(19) United States
(12) Patent Application Publication
(10) Pub. No.: US 2008/0147270 A1
(43) Pub. Date: Jun. 19, 2008

(54) Vehicle interior environment control system

(75) Inventors: Hiroyuki Sakane, Anjo-city (JP); Satoshi Takehisa, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/000,286

(22) Filed: Dec. 11, 2007

(30) Foreign Application Priority Data
Dec. 15, 2006 (JP) 2006-338948

(51) Int. Cl. B60H 1/00; G06F 7/00

(52) U.S. Cl. 701/36; 700/300

(57) ABSTRACT

A vehicle interior environment control system includes a plurality of environment adjustment sections adapted to operate in cooperation with each other so as to control optimization of an environment of a vehicle interior, a grading parameter setting section for setting a grading parameter indicative of a capacity grade of each of the environment adjustment sections in one-to-one relation to the environment adjustment sections, an environmental luxury degree setting section for adjustably setting an environmental luxury degree desired by a user for a total environmental adjustment state of the vehicle interior, and an integrated control section. The integrated control section controls the cooperation between the environment adjustment sections, such that as the environmental luxury degree set by the environmental luxury degree setting section becomes higher, the environment adjustment section with the higher capacity grade indicated by the grading parameter is preferentially operated.

### CROSS REFERENCE TO RELATED APPLICATION

This application is based on Japanese Patent Application No. 2006-338948 filed on Dec. 15, 2006, the contents of which are incorporated herein by reference in its entirety.

### FIELD OF THE INVENTION

The present invention relates to a vehicle interior environment control system for adjusting an environment of a vehicle interior.

### BACKGROUND OF THE INVENTION

Conventional vehicles are provided with environment adjustment sections for positively controlling environmental factors regarding comfort of the interior of a vehicle, for example, temperature, humidity, light, noise or sound, space, and the like. Some environment adjustment sections may have an influence on undesired environmental factor as a result of being controllably driven.

Specifically, the environment adjustment sections can include the following. Note that the terms inside the parentheses indicate the environmental factors on which the system can exert an influence.

Air Conditioning System (temperature, humidity)

Power Window System (temperature, humidity, sound, space)

Interior Lighting System (brightness, temperature (temperature feel), space (space feel))

Sunshade (brightness, temperature, space (space feel))

Dimming Glass (brightness, temperature, space (space feel))

Audio (sound)

Noise Canceller (sound, space (space feel))

Memory Sheet System (space)

The above environment adjustment sections are separately used by a user's operation of a predetermined operation part. For example, the user can use one or both of the air conditioning system and the power window system as control means of “room temperature”. The user can use the interior lighting system, the sunshade, and/or the dimming glass as means for changing the brightness of the interior of the vehicle.

However, when the user intends to selectively use the environment adjustment section, the user himself has to determine appropriately which system is to be used, and needs to operate the system according to conditions. In the prior art, because the user who does not have detailed information about components mounted on a vehicle selects and determines the environment adjustment section, the user may operate the component inappropriately against the user's request. In order to take an appropriate action, the user should consider whether the environment adjustment section to be employed is appropriate or not, whether a plurality of environment adjustment sections can be employed or not, and/or whether the system achieving the opposite effect is to be employed or not.

Specific examples in such conditions are as follows.

### EXAMPLE 1

### Compatibility Between “Power Saving” and “Comfort of Temperature”

In order to achieve a desired room temperature while saving the power, for example, while reducing the fuel consumption, the power window system may be intended to be used as the environment adjustment section other than the air conditioning system. In this case, this environment adjustment section needs to be used, considering and judging influences on other environmental factors, for example, inflow of noise from the vehicle exterior, given by the adjustment section at that time.

### EXAMPLE 2

### Compatibility Between “Defensive Safety “Security” and “Comfort of Brightness”

In order to achieve a desired external light shield while assuring the defensive safety (security), the dimming glass may be intended to be used as the environment adjustment section other than the sunshade. In this case, this environment adjustment section needs to be used, considering and judging influences on other environmental factors (for example, interruption of noise outside the vehicle, a change in room temperature of the vehicle interior, and the like) given by the adjustment section at that time.

### EXAMPLE 3

### Compatibility between “Health (Salubriousness)” and “Comfort of Sound in Vehicle Interior”

In order to achieve obtaining of the desired peripheral sound while taking into consideration an influence, for example, of exhaust gas, on the health (salubriousness), the noise canceller or means for emphasizing necessary sounds may be intended to be used as the environment adjustment section other than the power window. In this case, this environment adjustment section needs to be used, while considering and judging influences on other environmental factors, for example, changes in temperature and humidity by interruption of the outside air, and the like, given by the adjustment section at that time.

In other words, in order to perform an appropriate operation according to the user's request, the user himself needs to operate each environment adjustment section, by taking into consideration a control condition of a present environment of the vehicle interior environment, as well as influences on other environmental factors such as humidity, noise, space which are to be given in control of the respective environment adjustment sections at the present time, while judging the presence or absence of opposite effects. However, this is difficult for the user.

### SUMMARY OF THE INVENTION

It is an object of the invention to provide a vehicle interior environment control system which can select an appropriate environment adjustment section according to the user's request or expectation for a vehicle interior environment, that is, according to which grade (what degree of luxury) the user desires.

According to an aspect of the present invention, a vehicle interior environment control system includes: a plurality of environment adjustment sections adapted to operate in cooperation with each other so as to control optimization of an environment of an interior of a vehicle; grading parameter setting means for setting a grading parameter indicative of a capacity grade of each of the environment adjustment sections in one-to-one relation to the environment adjustment sections; environmental luxury degree setting means for adjustably setting an environmental luxury degree desired by a user for a total environmental adjustment state of the vehicle interior, achieved by the cooperation between the environment adjustment sections; and integrated control means. The integrated control means controls the cooperation between the environment adjustment sections, such that as the environmental luxury degree set by the environmental luxury degree setting means becomes higher, the environment adjustment section with the higher capacity grade indicated by the grading parameter is preferentially operated.

According to the above features of the present invention, in order to adjust the vehicle interior environment by combining some existing environment adjustment sections, the user has only to set a desired environmental luxury degree. The grading parameter indicative of the capacity grade is set for each environment adjustment section. The integrated control means controls the cooperation between the environment adjustment sections such that as the environmental luxury degree is set higher, the environment adjustment section with the higher capacity grade indicated by the grading parameter is preferentially performed. Thus, the user can select the appropriate environment adjustment section according to a requirement and an expectation for the vehicle interior environment without being bothered with complicated cooperation adjustment including opposite operations.

The vehicle interior environment control system may includes environmental luxury degree input means which is operated for input by a user in the vehicle interior. In this case, the environmental luxury degree setting means may set the environmental luxury degree based on an input state of the environmental luxury degree input means. This structure enables the user to freely input the environmental luxury degree according to the requirement and expectation for the vehicle interior environment, and thus to flexibly select the environment adjustment section.

The vehicle interior environment control system may further include required capacity value setting means for setting a required capacity value for optimization of the vehicle interior environment as a numerical value parameter for each of the environment adjustment sections. Here, the numerical value parameter may be directly comparable between the environment adjustment sections. In this case, the integrated control means includes: total luxury-degree-reflecting capacity value calculation means for calculating a total luxury-degree-reflecting capacity value which is a numerical value parameter directly comparable with the required capacity value, based on the set value of the environmental luxury degree; integrated required-capacity-value computation means for computing an integrated required capacity value by integrating and computing the required capacity values set in the respective environment adjustment sections according to a pre-set computation procedure; and capacity value comparison means for comparing the total luxury-degree-reflecting capacity value with the integrated required capacity value. Furthermore, the integrated control means controls the cooperation between the environment adjustment sections such that as the integrated required capacity value is closer to the total luxury-degree-reflecting capacity value, the environment adjustment section having the lower capacity grade is preferentially performed.

The final adjustment of the vehicle interior environment is performed by the individual environment adjustment sections. With the above-described arrangement, each environment adjustment section individually sets the required capacity value for optimization of the interior environment. The total luxury-degree-reflecting capacity value, which is a numerical parameter directly comparable with the above-described individual required capacity value, is computed based on the set value of the environmental luxury degree. Here, the dimension of the set value of the environmental luxury degree may be included in the dimensions of the capacity values from the beginning. On the other hand, the required capacity values set by the respective environment adjustment sections are integrated and computed according to the predetermined computation procedure to calculate the integrated required capacity value, which is then compared with the above-described total luxury-degree-reflecting capacity value. When the total luxury-degree-reflecting capacity value is larger, the environment adjustment section with the higher capacity grade can be operated because the user desires the high luxury degree. Conversely, when the total luxury-degree-reflecting capacity value is smaller, that is, when the total luxury-degree-reflecting capacity value is closer to the integrated required capacity value, the inexpensive environment adjustment section in which the luxury degree desired by the user is not so high and which has the lower capacity grade is preferentially operated. In this way, the cooperation between the environment adjustment sections can be appropriately controlled according to the luxury degree desired by the user.

The integrated required-capacity value computation means may add up and integrates the required capacity values of the low-level control systems, and thus can simplify a computation algorithm of the integrated required capacity value, but is not limited thereto. Various modifications can be made to the integrated required-capacity value computation means. For example, the computation means may assign weights to the required capacity values, and may then add up and integrate them, if necessary.

The environment adjustment sections may have the respective independent low-level control systems. Furthermore, the low-level control system may include: a low-level control main body for comparing a present detected value of a vehicle interior environmental control factor to be controlled with a target value and for performing feedback control of a control amount of interest based on a comparison result such that the present detected value is close to the target value; the required capacity value setting means for updating and setting the required capacity value based on a set value of the control amount according to a change of the set value by the feedback control; and required capacity value output means for outputting and feeding back the required capacity value to an upper-level control system serving as the integrated control means. In this case, the integrated required-capacity-value computation means in the upper-level control system may be adapted to compute the integrated required capacity value based on a feedback input of the required capacity value from each of the low-level control systems.

The environment adjustment section for directly controlling the optimization of the vehicle interior environmental control factor may be provided with a low-level control main body. The control main body compares the present detected value of the vehicle interior environment control factor of interest to be controlled with the target value, and then performs feedback control of the control amount of interest based on the comparison result such that the present detected value is close to the target value. The required capacity value is generated based on the control amount updated on the above-described lower-level control main body, and then returned toward the upper-level control system serving as the integrated control system. In this way, a two-stage feedback system can be constructed. Thus, an updating process of the required capacity value for selecting the environment adjustment section according to the comparison result between the environment luxury degree and the integrated required capacity value can be separated from a direct control process performed for each environment adjustment section.

Thus, it is possible to achieve stabilization of the control, while flexibly performing addition, cancellation, and the like of the environment adjustment section together with a change in specifications of the vehicle.

The initial value of the required capacity value can be the maximum capacity value of the individual environment adjustment section, thereby allowing the vehicle interior environment to converge to the target value even in an initial state where the interior environment is largely apart from the target value.

The required capacity value may also serve as the grading parameter, and the environment adjustment section having the larger required capacity value set may be defined as positioned on an upper level of the capacity grade.

With this arrangement, the environment adjustment section having a larger potential adjustment capacity of the vehicle interior environment of interest can appear to have a larger capacity to contribute to the optimization of the vehicle interior environment, that is, the larger required capacity value. When the required capacity value is defined as the above-described grading parameter, the environment adjustment section having the larger required capacity value consumes the large energy in a redundant manner, and thus can be positioned as a so-called “high-luxury degree” environment adjustment section.

The upper-level control system may include: luxury redundant capacity value computation means serving as the capacity value comparison means for computing a luxury redundant capacity value represented by a difference between the total luxury-degree-reflecting capacity value and the integrated required capacity value; and environment adjustment section selecting means for selecting which one of the environment adjustment sections is operated based on a comparison result between the luxury redundant capacity value and the integrated required capacity value from each of the low-level control systems.

The total luxury-degree-reflecting capacity value determined by the upper-level control system is a total capacity value corresponding to the luxury degree set by the user. The larger this value, the more luxuriously the environment adjustment section can be used. The above-described luxury redundant capacity value can be used as an index representing to what degree the redundant environment adjustment section can be used with reference to the required capacity value fed back from the low-level control system. The result of comparison between the luxury redundant capacity value and the integrated required capacity value can appropriately select which one of the environment adjustment sections is to be operated.

In the vehicle interior environment control system, the temperature of the vehicle interior may be defined as the vehicle interior environmental factor. In this case, all of the target value, the required capacity value, the integrated required capacity value, and the luxury redundant capacity value may have a dimension of temperature.

For example, when the vehicle interior temperature is defined as the vehicle interior environmental factor, all of the target value, the required capacity value, the integrated required capacity value, and the luxury redundant capacity value are defined to have the dimension of temperature. Thus, the control amount to be compared with the target value by the low-level control system is represented by the dimension of temperature, which can considerably simplify the computation of each capacity value and the algorithm of the comparison process.

Accordingly, when the luxury redundant capacity value exceeds the integrated required capacity value, the environment adjustment section selecting means selects all environment adjustment sections as the operable environment adjustment section. In contrast, when the luxury redundant capacity value falls below the integrated required capacity value, the environment adjustment section selecting means preferentially selects one with the smaller required capacity value from among the environment adjustment sections. That is, when the luxury redundant capacity value is not ensured sufficiently, the environment adjustment section with the smaller required capacity value is preferentially selected, so as to enable the user to easily understand a saving environment control state. In this case, a part of the environment adjustment sections is selected such that the integrated required capacity value is maximized in a range below the luxury redundant capacity value, which can maintain the saving environment control state, while keeping a good control efficiency. In particular, the part of the environment adjustment sections is selected such that the integrated required capacity value is maximized in the form to exclude one or more environment adjustment sections positioned on the upper level of a rank order of the required capacity values. This can further simplify the algorithm associated with selection and exclusion of the environment adjustment section.

The environment adjustment section may include either an active operation section or a passive operation section, the active operation section being adapted to operate so as to offset disturbance from a vehicle exterior, which may keep the vehicle interior environmental factor of interest away from the target value, by positively introducing energy, the passive operation section being adapted to operate so as to prevent the disturbance from entering the vehicle interior in the same manner, or so as to use disturbance acting in such a direction to put the vehicle interior environmental factor of interest closer to the target value.

The active operation section needs positive introduction of the energy from the vehicle side in order to offset disturbance from the vehicle exterior, and thus can be regarded as a consumption type environment adjustment section. In contrast, the passive operation section saves the energy to be introduced from the vehicle side by preventing the disturbance, or by using disturbance acting to put the vehicle interior environmental factor closer to the target value, and thus can be regarded as a production type environment adjustment section acting in the direction to recover the energy. Therefore, the passive operation section is preferentially operated to contribute to the recovering of the energy, which can enlarge an allowable capacity margin for additionally operating the active operation section.

In this case, the required capacity value setting means may be adapted to set the required capacity values with opposite signs to each other for the active and passive operation sections such that the active operation section contributes to increase the integrated required capacity value, while the passive operation section contributes to decrease the integrated required capacity value.

A control algorithm for selecting the environment adjustment section based on the comparison result between the environmental luxury degree and the integrated required capacity value can be widely applied reasonably to the control form in which the passive operation section is included.

Furthermore, the control system may include disturbance comparison means for detecting a present vehicle interior value of the vehicle interior environmental factor and for comparing the present vehicle interior value with a vehicle exterior disturbance value corresponding thereto and the target value; and passive operation section control means for controlling an operation of the passive operation section based on a comparison result.

The passive operation section operates so as to prevent the disturbance from entering the vehicle interior, or so as to use disturbance acting in such a direction to put the vehicle interior environmental factor of interest closer to the target value, as mentioned above. Thus, the present vehicle interior value of the vehicle interior environmental factor can be compared with the vehicle exterior disturbance value and the target value thereby to appropriately determine which one of the operations of the environment adjustment sections is to be selected.

More specifically, the passive operation section control means may operate so as to use the disturbance when a difference determined by subtracting the target value from the present vehicle interior value has the same sign as that of a difference determined by subtracting the vehicle exterior disturbance value from the present vehicle interior value, and may likewise operate so as to interrupt the disturbance when said differences have opposite signs.

For example, when the vehicle interior temperature is defined as the vehicle interior environmental factor, and the active operation section is a vehicle interior air conditioner, the passive operation section can be the power window mechanism.

The vehicle interior temperature may be defined as the vehicle interior environmental factor, the active operation section may be a vehicle interior air conditioner, and the passive operation section may be a power window mechanism. In this case, the power window mechanism may be adapted to operate in an opening direction when the vehicle interior temperature is lower than the target temperature and the vehicle exterior temperature is higher than the vehicle interior temperature, or when the vehicle interior temperature is higher than the target temperature and the vehicle exterior temperature is lower than the vehicle interior temperature, the power window mechanism may be further adapted to operate in a shielding direction when the vehicle interior temperature is lower than the target temperature and the vehicle exterior temperature is lower than the vehicle interior temperature, or when the vehicle interior temperature is higher than the target temperature and the vehicle exterior temperature is higher than the vehicle interior temperature.

In the case where the vehicle interior temperature is lower than the target temperature and the vehicle exterior temperature is higher than the vehicle interior temperature, the window is opened, so that the vehicle interior temperature can be closer to the target value, which can reduce a load on the air conditioner. The same goes for the case where the vehicle interior temperature is higher than the target temperature and the vehicle exterior temperature is lower than the vehicle interior temperature. Alternatively, in the case where the vehicle interior temperature is lower than the target temperature and the vehicle exterior temperature is lower than the vehicle interior temperature, the window is opened to allow only cold air to flow into the vehicle, which keeps the vehicle interior temperature further apart from the target value. Thus, the window is closed. In this case, closing the window can reduce the load on the air conditioner, as compared to the case of opening the window, because the temperature is avoided from further decreasing due to the inflow of the outside air. The same goes for the case where the vehicle interior temperature is higher than the target value and the vehicle exterior temperature is higher than the vehicle interior temperature.

When employing the control algorithm using the above-described luxury redundant capacity value, the required capacity value setting means sets the required capacity values with opposite signs for the active and passive operation sections in the following manner. The active operation section contributes to decrease the luxury redundant capacity value, while the passive operation section contributes to increase the luxury redundant capacity value. That is, when the passive operation section is preferentially employed, the luxury redundant capacity value is increased, which can generate a margin for employing the active operation section. When the luxury redundant capacity value falls below the required capacity value of the active operation section, the passive operation section is preferentially selected rather than the active operation section, which can relatively limit the operation of the active operation section. Thus, the luxury redundant capacity value can be recovered, and then the limited state of operation of the active operation section can be recovered.

Specifically, when the luxury redundant capacity value falls below the integrated required capacity value while the environment adjustment operation sections in operational selection include both of the active operation section and the passive operation section, the environment adjustment section selecting means excludes at least a part of the active operation section in the operational selection from the selection. At least the part of the active operation section in the operational selection is excluded, so that the contribution of the passive operation section has relative superiority, thereby enabling the recovery of the luxury redundant capacity value. More specifically, when the luxury redundant capacity value is zero or a negative value while the environment adjustment sections in operational selection include both of the active operation section and the passive operation section, the environment adjustment section selecting means is adapted to more effectively exclude the entire active operation section in the operational selection from the selection. And, the selecting means is adapted to select only the passive operating section to be operated. When the luxury redundant capacity value is recovered to a predetermined level on a positive value side while only the passive operation section is selected to be operated, the selecting means can recover and select at least a part of the active operation section which has been selected and excluded in such a range that the luxury redundant capacity value thereof does not fall below the integrated required capacity value. That is, even the active operation section which cannot be used due to a shortage of the luxury redundant capacity value can be used again when the luxury redundant capacity value is recovered sufficiently.

With this arrangement, the selection and exclusion of the active operation section is basically performed automatically. Thus, when the luxury redundant capacity value is lacking, the active operation section cannot be performed again as it is. Manual selection receiving means is provided for receiving user's manual selection of the active operation section whose operation is not selected by the environment adjustment section selecting means. Thus, the active operation section excluded according to the user's requirement can be operated. It is apparent that the manual operation is needed, which makes the grade of the luxury degree lower. In this case, the manual selection receiving means can be adapted to receive the manual selection only when the luxury redundant capacity value is equal to or less than zero.

A main object of the control of optimization among the vehicle interior environmental factors is defined as a main vehicle interior environmental factor, and another vehicle interior environmental factor concomitantly changing is defined as a dependent vehicle interior environmental factor. A subsidiary environment adjustment section can be provided for controlling the optimization of the dependent vehicle interior environmental factor. In this case, the integrated control means can also control the subsidiary environment adjustment section. That is, even when the state of the dependent vehicle interior environmental factor is disturbed due to a cause in the system by the control operation of the main vehicle interior environmental factor, the subsidiary environmental adjustment section is provided and controlled by the integrated control means, thereby enabling elimination of the disturbance. This can comprehensively create the more comfort vehicle interior environment. In this case, a part of the main environment adjustment section for performing the control of optimization of the main vehicle interior environmental factor can also serve as the subsidiary environment adjustment section. This enables reduction in weight of the system structure, thereby preventing the disturbance of the dependent vehicle interior environmental factor.

Specifically, when the main vehicle interior environmental factor is the vehicle interior temperature, the main environment adjustment sections can be the vehicle interior air conditioner and the power window mechanism. In the vehicle interior air conditioner, a blower or the like is a noise generating source. When the window is opened by the power window mechanism, noise enters the interior of the vehicle from the outside. Thus, the dependent vehicle interior environment factors can be levels of noise and a signal sound in the vehicle interior (music sound or important sound outside the vehicle (a horn sound of another car, a siren sound of an emergent vehicle, or an alarm sound of a crossing plate, or the like)), and more specifically, a S/N ratio. For example, the S/N ratio is a ratio of the signal sound level to the noise level. In this case, the subsidiary environment adjustment section can include an audio system for outputting audio as the signal sound, and a noise canceller for reducing the noise level. That is, the audio system enhances the music sound level, while the noise canceller reduces the noise level, both of which contribute to improvement of the S/N ratio.

In this case, the power window mechanism which is one of the main environment adjustment sections can also serve as the subsidiary environment adjustment section. That is, when the window is opened by the power window mechanism for the control of the vehicle interior temperature, noise outside the vehicle enters the vehicle interior. However, by shifting an object of the main control toward the air conditioner which is the active operation section, the power window mechanism can be converted to the subsidiary environment adjustment section for shielding the noise outside the vehicle (that is, the power window mechanism is operated in the shielding direction, which can appropriately control the temperature of the vehicle interior, while achieving the S/N ratio).

In this case, vehicle interior S/N ratio input means can be provided which is operated for input by the user in the vehicle interior. Thus, the integrated control means can be configured to control cooperation among the audio system, the noise canceller, and the power window mechanism so as to obtain the vehicle interior S/N ratio indicated by the input state into the vehicle interior S/N ratio input means. The conventional audio system can change only the amount of sound. Thus, as the noise level becomes higher, there is no way to increase a relative level of the music sound in the conventional system other than to set the amount of sound output to such a level to overcome the noise level. This may tend to place a higher load on auditory sense. In this embodiment, the use of the above-described vehicle interior S/N ratio input means can increase the relative level of the music sound, taking into consideration reduction in noise level. This can reduce the load on the auditory sense, and freely adjust the relative level of the music sound.

### BRIEF DESCRIPTION OF THE DRAWINGS

Additional objects and advantages of the present invention will be more readily apparent from the following detailed description of preferred embodiments when taken together with the accompanying drawings. In which:

FIG. 1 is a diagram showing cooperation among control systems included in a vehicle interior environment control system;

FIG. 2 is a schematic block diagram of the vehicle interior environment control system;

FIG. 3 is a block diagram showing an entire configuration of the vehicle interior environment control system;

FIG. 4 is a diagram for explaining a relationship between target environmental controllability levels and necessary amounts of introduced resources (capacity values);

FIG. 5 is a flowchart for explaining a flow of control of system selection by the vehicle interior environment control system;

FIG. 6 is a table into which a capacity value of the control system for each environmental factor is input;

FIG. 7 shows an example of inputs in the table shown in FIG. 6;

FIG. 8 is a diagram showing selection patterns of the control systems;

FIG. 9 shows a first example of a driving procedure of each control system for the environmental factor of “temperature”;

FIG. 10 shows a second example of a driving procedure of each control system for the environmental factor of “temperature”;

FIG. 11 shows a third example of a driving procedure of each control system for the environmental factor of “temperature”;

FIG. 12 shows a fourth example of a driving procedure of each control system for the environmental factor of “temperature”;

FIG. 13 is a block diagram schematically showing an entire configuration of an air conditioning control system;

FIG. 14 is a diagram showing a positional relationship between air outlets disposed in the interior of a vehicle;

FIG. 15 is a block diagram schematically showing an entire configuration of a power window control system;

FIG. 16 is a block diagram schematically showing an entire configuration of an interior light control system;

FIG. 17 is a block diagram schematically showing an entire configuration of a sunshade control system;

FIG. 18 is a diagram for explaining a developed state of the sunshade in a vehicle;

FIG. 19 is a block diagram schematically showing an entire configuration of a dimming glass control system;

FIG. 20 is a block diagram schematically showing an entire configuration of an audio control system;

FIG. 21 is a block diagram schematically showing an entire configuration of a noise canceller control system;

FIG. 22 is a block diagram showing one example of a hardware configuration of the noise canceller control system shown in FIG. 21;

FIG. 23 is a block diagram schematically showing an entire configuration of a memory sheet control system; and

FIG. 24 is a diagram for explaining a driving position.

### DETAILED DESCRIPTION OF THE PREFERRED EMBODIMENTS

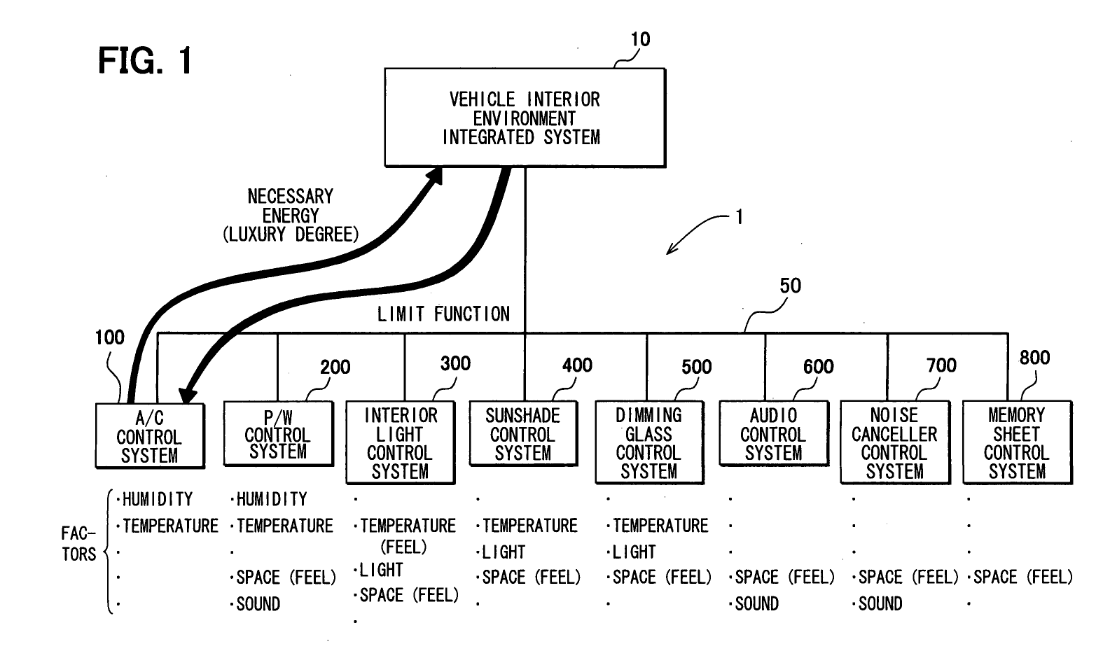

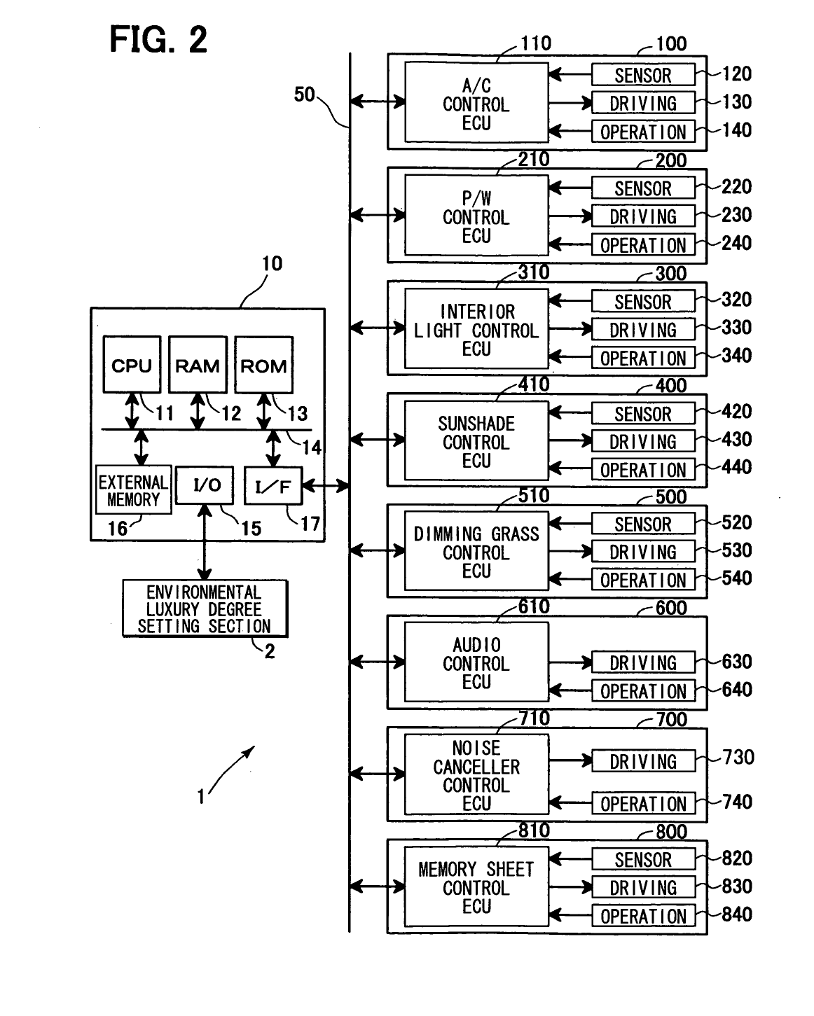

An embodiment and its examples of the invention will be described below with reference to the accompanying drawings. FIG. 1 is a diagram showing combination of control systems included in a vehicle interior environment control system of the invention. FIG. 2 is a schematic block diagram of the vehicle interior environment control system. The vehicle interior environment control system 1 shown in FIGS. 1 and 2 includes low-level control systems 100 to 800 for adjusting optimization of an environment of the interior of a vehicle, and an upper-level vehicle interior environment integrated control system (upper-level integrated control system, integrated control means) 10 for controlling cooperation among these control systems 100 to 800. The low-level control systems 100 to 800 and the upper-level integrated control system 10 are connected via a LAN 50 in the interior of the vehicle. The low-level control systems 100 to 800 are adapted to control any respective environmental factors of the vehicle interior.

Each of the low-level control systems 100 to 800 includes: a control ECU; and a sensor section, a driving section and an operation section which are connected to the ECU, as shown in FIG. 2. In this embodiment, the low-level control systems include an air conditioning control system 100, a power window control system 200, an interior light control system 300, a sunshade control system 400, a dimming glass control system 500, an audio control system 600, a noise canceller control system 700, and a memory sheet control system 800.

The low-level control systems 100 to 800 are configured to function independently even when not receiving an instruction or management from the upper-level vehicle interior environment integrated system 10. The independent functions of the low-level control systems 100 to 800 will now be described below.

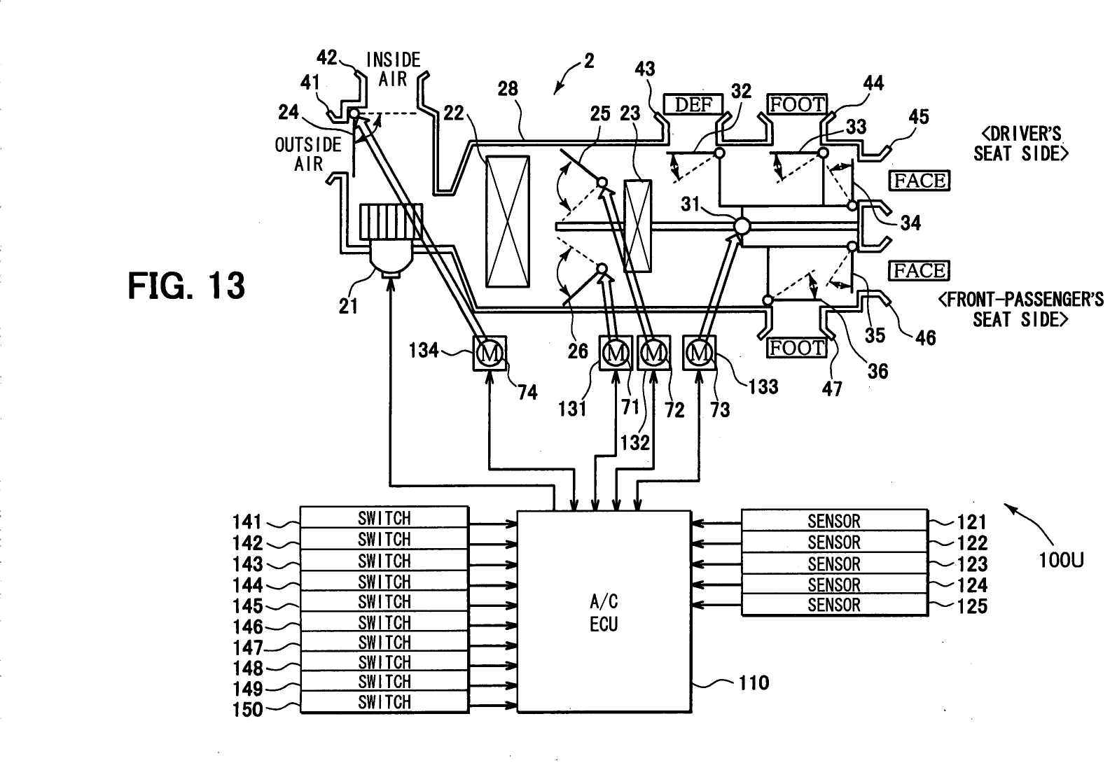

As shown in FIG. 2, the air conditioning control system 100 includes an air conditioning control ECU 110 (A/C ECU), and a sensor section 120, a driving section 130, and an operation section 140 which are connected to the ECU 110. FIG. 13 is a schematic diagram showing an entire configuration of an air conditioning section 100U controlled by the air conditioning control ECU 100. The air conditioning section 100U is a so-called HVAC (Heating, Ventilating and Air-Conditioning), and is configured to be capable of independently adjusting air-conditioned states on a driver seat side and on a front-passenger seat side of the vehicle interior.

A duct 28 of the air conditioning section 100U is provided with an inside air inlet 42 for circulating air (inside air) in the vehicle interior, and an outside air inlet 41 for taking in air (outside air) outside the vehicle. An internal/external air switching damper 24 is used to switch between the inside and outside air inlets. The air from the inside air inlet 42 or the outside air inlet 41 is sucked into the duct 28 by a blower 21. In the duct 28, an evaporator 22 is provided for cooling the sucked air and generating the cooled air. An air stream is branched on the downstream side (air outlet side) of the evaporator 22 into a stream leading to air outlets 43 to 45 on the driver seat side and a stream leading to air outlets 46 and 47 on the front-passenger seat side.

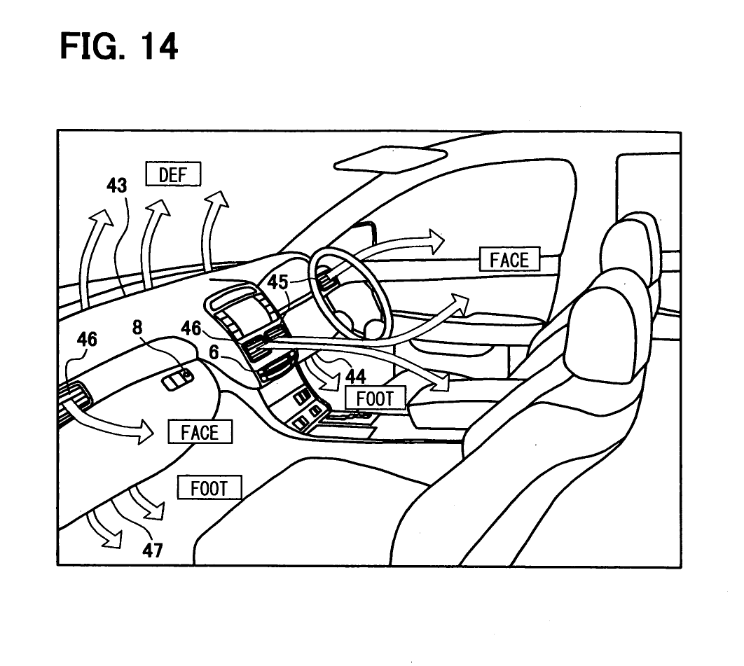

As shown in FIG. 14, the air outlet portion of the air conditioning section 100U includes defroster air outlets 43 adapted for preventing windshield fogging and provided to be opened in the back of an upper part of an instrument panel corresponding to a lower edge of the inner surface of the windshield. The air outlets also include face air outlets 45 on the driver seat side respectively provided to be opened on the right side of the center of the front surface of the instrument panel and at the right edge thereof, face air outlets 46 on the front passenger seat side respectively provided to be opened on the left side of the center of the front surface of the instrument panel and at the left edge thereof. Further, the air outlet includes a foot air outlet 44 on the driver seat side provided to be opened on the foot side of the driver seat in the back of a right part on the lower side of the instrument panel. Moreover, the air outlets include foot air outlets 47 on the front passenger seat side provided to be opened on the foot side of the front passenger seat in the back of a left part on the lower side of the instrument panel. These air outlets 43, 44, 45, 46, 47 are switched between open and closed states by dampers 32 to 36 for switching the air outlets.

The driving section 130 connected to the air conditioning control ECU 110 includes a damper driving gear mechanism 31 for respectively switching air mix dampers 25, 26, the inside/outside air switching damper 24, the dampers 32 to 36 for switching the air outlets, and a damper driving gear mechanism 31 for switching between open and closed states of the dampers 32 to 36. The driving section 130 also includes servo motors 71 to 74 for driving the above-described elements. These servo motors (actuators) 71 to 74 are rotatably controlled by the air conditioning control ECU 100, and detect information about a rotation position or rotation velocity of a rotor to perform feedback to the air conditioning ECU 110. Specifically, driving circuits 131 to 134 receive inputs of driving command signals from the air conditioning ECU 110 to drive the respective servo motor 71 to 74.

The sensor section 120 connected to the air conditioning control ECU 110 is constructed of the well-known sensors for air-conditioning control, which include an inside air temperature sensor 121, an outside air temperature sensor 122, a post-evaporator sensor 123, a solar radiation sensor 124, a humidity sensor 125, and the like.

The operation section 140 is provided in the operation panel located in the center of the front surface of the instrument panel. The operation section 140 is constructed of the well known operation parts for air-conditioning control, which include an AUTO switch 141, an OFF switch 142, an air outlet selector switch (MODE switch) 143, an inside/outside air selector switch 144, an air amount selector switch 145, a temperature setting switch 146, a defroster switch 147, an A/C switch 148, an independent/integrated control selector switch (DUAL switch) 149, a humidifier operation switch 150, and the like.

The air conditioning control ECU 110 has the well-known structure including a CPU, a ROM, a RAM, and the like. The ECU 110 controls the driving of the driving section 130 based on the operated state of the operation section 140 and the result of detection of the sensor section 120, thereby performing the well-known air conditioning control, which includes air blow-off temperature control, air amount control, switching control between the inside and outside suction airs, switching control between the air outlets, and the like. The air blow-off temperature control is executed when the AUTO switch is turned on to calculate a target air blow-off temperature TAO based on the detection result of the sensor section 120. Then, the air blow-off temperature control can control driving of the air mix dampers 25 and 26 based on the result of calculation, and also control the temperature, which is an environmental factor of the interior of the vehicle. The air conditioning section 100U is provided with a humidifier not shown which is operated based on the operation of the humidifier operation switch 150, thereby controlling the humidity, which is an environmental factor of the vehicle interior.

The power window control system 200 includes a power window control ECU 210; and a sensor section 220, a driving section 230, and an operation section 240 which are connected to the ECU 210.

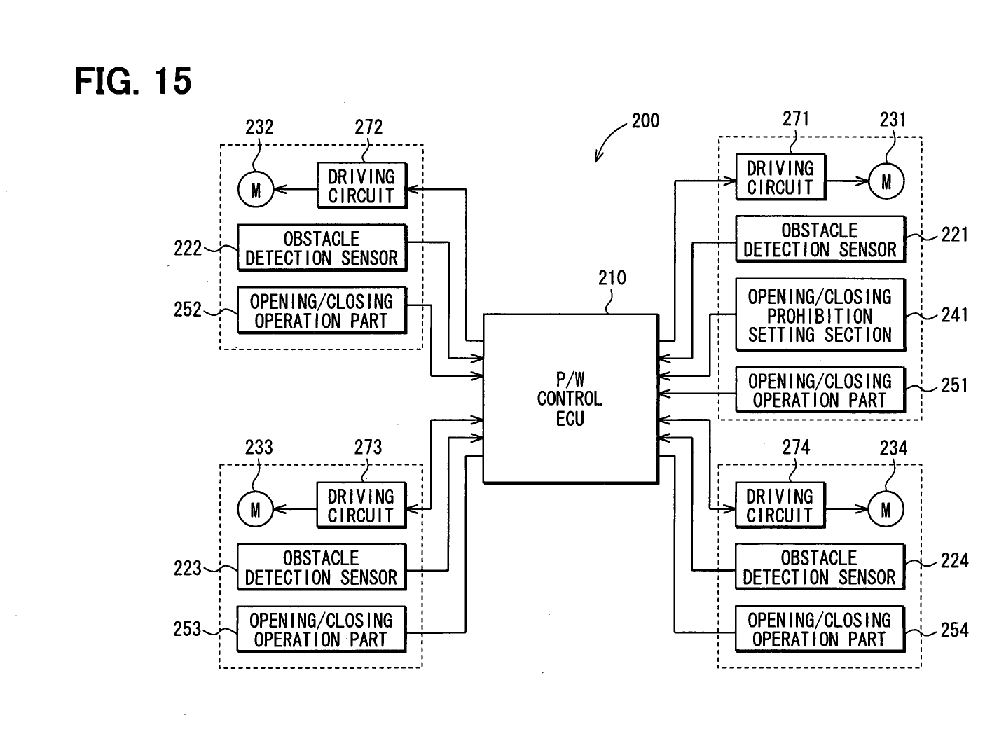

As shown in FIG. 15, the driving section 230 includes driving circuits 271 to 274 for driving motors connected to the power window control ECU 210, and motors 231 to 234 capable of being rotated in forward and reverse directions. The motors 231 to 234 are constructed of DC motors in this embodiment (it is apparent that any other kind of motor, such as an induction motor, a brushless motor, or a stepping motor, can be used). The driving circuits 271 to 274 and the motors 231 to 234 are provided in windowpanes of respective seats in the vehicle, for driving the opening and closing of the respective windowpanes.

The operation section 240 is located in a position where a passenger on the driver seat can manipulate, and includes an opening/closing prohibition setting operation part 241 for setting a lock state (prohibition of opening and closing) and an unlock state (admission of opening and closing) so as to open and close the windows corresponding to the seats other than the driver seat, and opening/closing operation parts 251 to 254 provided on the respective seats for driving the opening and closing of the windowpanes of the seats.

The sensor section 210 includes obstacle detection sensors (obstacle detection means) 221 to 224 for detecting obstacles in moved areas of the windowpanes. These sensors are provided in the respective window panes.

The power window control ECU 210 has the well-known structure, including the CPU, the ROM, the RAM, and the like. When the operation of any one of the opening/closing operation parts 251 to 254 is performed by the user while the opening/closing prohibition setting section 241 is in the unlock state (allowed to be open or closed), the power window control ECU 210 gives driving commands to the respective driving circuits 271 to 274 based on the content of the user's operation, and drives the motors 231 to 234 toward an open or closed position. When the corresponding obstacle detection sensor 220 detects an obstacle in the windowpane being driven toward the closed position, control is executed to stop driving of the windowpane toward the closed position.

The interior light control system 300 includes an interior light control ECU 310, a sensor section 320, a driving section 330, and an operation section 340.

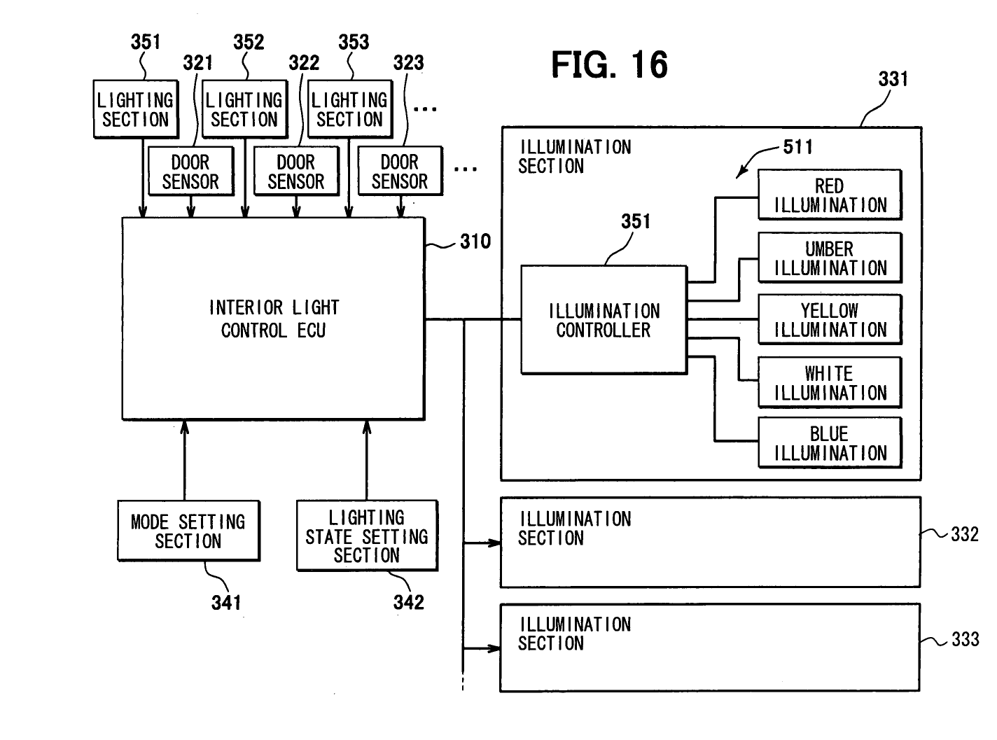

As shown in FIG. 16, the driving section 330 includes illumination sections 331, 332, 333, . . . disposed in a plurality of positions in the vehicle interior for illuminating a ceiling surface and side surfaces of the vehicle interior, in addition to a room lamp or a foot lamp. Each illumination section includes illumination parts consisting of specific illumination colors (in this embodiment, a red illumination 371r, an umber illumination 371u, an yellow illumination 371y, a white illumination 371w, and a blue illumination 371b), and a driving circuit (illumination controller shown in the figure) 351 for driving these illumination parts. As the driving section 330 including these illumination sections may be used a filament lamp, a fluorescent lamp, or an illumination device using a light emitting diode. In particular, the combination of light emitting diodes of three primary colors consisting of red (R), green (G), and blue (B) can easily obtain various kinds of illumination lights.

The sensor section 320 includes door open/closed state detection sensors 321 to 323 (door sensors) for detecting open and closed states of the doors in the vehicle. These sensors 321 to 323 are provided in the respective doors of the vehicle.

The operation section 340 includes a mode setting section 341 for setting one of a first mode for turning on and off the illumination section in a predetermined color (for example, the yellow illumination 371y), a second mode for continuing turning on the illumination section in the predetermined color (for example, the yellow illumination 371y), and a third mode for turning off the illumination section, based on the open or closed state of the above door, that is, only when the door is open. The operation section 340 also includes a lighting state setting section 342 for setting a lighted color or lighted pattern of the illumination section, and manual lighting sections 351 to 353 . . . disposed independently from the operation sections 341 and 342, for continuing turning on the respective illumination sections 330 (331 to 333) by the user's operation. The lighting state setting section 342 and the manual lighting operation sections 351 to 353 . . . are provided corresponding to the illumination sections 331 to 333.

The interior light control ECU 310 drives and turns on the respective illumination sections serving as the driving section 330 in cooperation with the operation of a door handle when the first mode is set by the mode setting section 341. Specifically, when all door open/closed state detection sensors 321 to 324 detects the closed states of the doors, the illumination sections remains in a non-lighted state. When any one of the door open/closed state detection sensors 321 to 324 detects the open state of any one of the doors, the illumination section 330 (331 to 333, . . . ) are lighted up based on the set state by the lighting state setting section 342.

The sunshade control system 400 includes a sunshade control ECU 410, and a sensor section 420, a driving section 430, and an operation section 440 which are connected to the ECU 410.

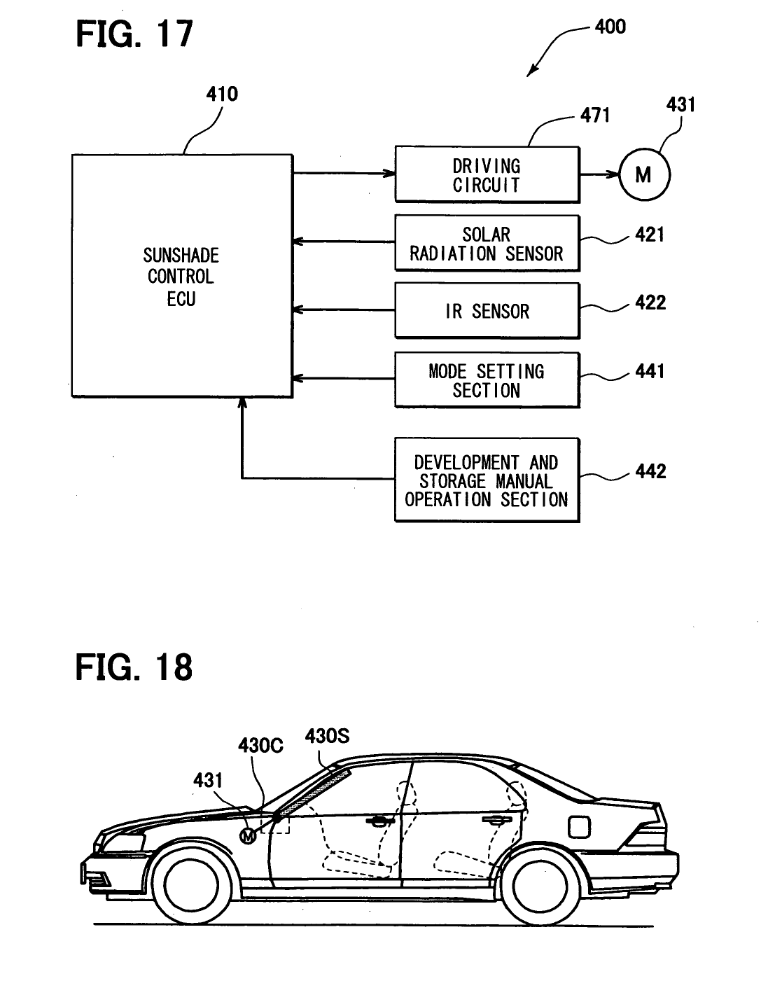

The driving section 430 includes a driving circuit 471 for driving a motor, which is connected to the sunshade control ECU 410 shown in FIG. 17, and a motor 431 capable of being rotated in both forward and reverse directions so as to develop and store a sunshade body 430S. As shown in FIG. 18, the sunshade body 430S is developed so as to cover the inner side of the windshield of the vehicle from a storage case 430C disposed in the back of the upper part of the instrument panel away from the air conditioning outlet 43 to serve as an example of solar radiation reduction means.

The sensor section 420 includes an IR sensor 422 serving as unmanned state confirming means for confirming an unmanned state by detecting a biological temperature in the vehicle interior (for example, an electric heating element having a temperature of 30 degrees or more), and a solar radiation sensor 421 serving as vehicle thermal load detection means for detecting an amount of solar radiation from the outside of the vehicle into the interior thereof via the windowpane covered with the sunshade body 430S.

The operation section 440 includes a mode setting section 441 for switching between a manual mode for driving the sunshade body 430S according to a user's manual and an automatic mode for automatically driving the sunshade body 430S based on the results of detection by the IR sensor 422 and the solar radiation sensor 421. The operation section 440 also includes a development and storage manual operation section 442 for developing and storing the sunshade body 430S according to the user's manual operation.

The sunshade control ECU 410 has the well-known structure including the CPU, the ROM, the RAM, and the like. When the mode setting section 441 sets the sunshade body 430S in the automatic mode, sunshade automatic driving control is executed. In execution of the sunshade automatic driving control, first, it is determined whether the vehicle is being parked or not. This is determined based on whether or not an off signal is received from an engine ignition operation section not shown (ignition switch). When the off signal is received, the vehicle is determined to be being parked. When the vehicle is being parked, it is determined whether or not the biological temperature of the vehicle interior (for example, the electric heating element having a temperature of 30 degrees or more) is detected from the detection result of the IR sensor. Furthermore, it is determined whether the amount of solar radiation detected by the solar radiation sensor exceeds a predetermined threshold or not. As a result, when it is determined that the vehicle interior is in the unmanned state and that the amount of solar radiation exceeds the threshold value, a sunshade development driving command is sent to the driving circuit 471 to drive the motor 431, thereby developing the sunshade body stored. When the on signal is received from the engine ignition operation section in developing the sunshade body, a sunshade storage driving command is sent to the driving circuit 471 to drive the motor 431, thereby storing the developed sunshade body 430S into the storage case 430C.

The dimming glass control system 500 includes a dimming glass control ECU 510; and a sensor section 520, a driving section 530, and an operation section 540 which are connected to the ECU 510.

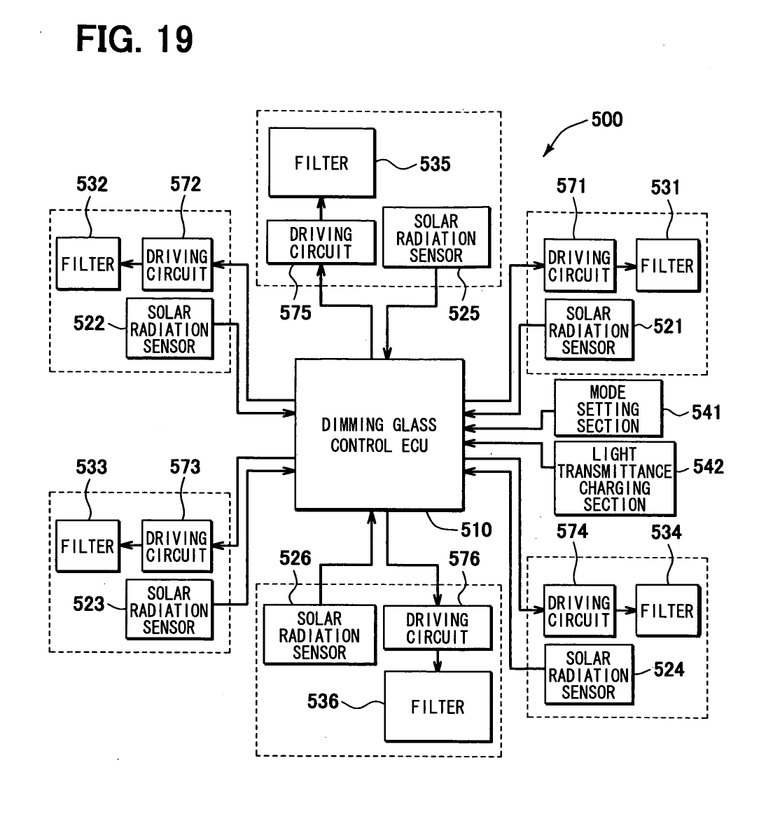

The driving section 530 serves as glare reduction means. In this embodiment, as shown in FIG. 19, the driving section 530 includes film-like liquid crystal filters 531 to 536 each for changing a light transmittance according to an applied voltage, and driving circuits 571 to 576 for changing voltages applied to the liquid crystal filters 531 to 536 based on commands from the dimming glass control ECU 510. The liquid crystal filters 531 to 536 are attached to the windshield, the back glass, and the door glasses of the seats in the vehicle, and provided with respective driving sections 530. The liquid crystal filters 531 to 536 of this embodiment are brought into a light-shielded state by applying a voltage that is equal to or higher than a predetermined voltage, while into a light-transmitting state by applying a voltage below the predetermined voltage (that is, into a state where the filters have light transmittances so as not to interrupt the vehicle running). In this embodiment, the liquid crystal filters are provided, and the glass whose light transmittance is changeable is herein referred to as the “dimming glass”.

The sensor section 520 serves as glare detection means, and includes solar radiation sensors 521 to 526 for detecting the amounts of solar radiation from the outside of the vehicle into the interior thereof via the windowpanes in this embodiment. Theses sensors 521 to 526 are provided in the respective windowpanes.

The operation section 540 includes a mode setting section 541 for switching between a manual mode for changing the light transmittance of the dimming glass according to a user's manual and an automatic mode for automatically changing the light transmittance of the dimming glass based on results of detection of the solar radiation sensors 521 to 526. The operation section 540 also includes a light transmittance changing section 542 for changing the light transmittance of the dimming glass according to the user's manual operation.

The dimming glass control ECU 510 has the well-known structure including the CPU, the ROM, the RAM, and the like. The dimming glass control ECU 510 executes the automatic changing control of the light transmittance when the automatic mode is set by the mode setting section 541. In execution of the automatic changing control of the light transmittance, first, it is determined whether the vehicle is being parked or not. This is determined based on whether or not an off signal is received from the engine ignition operation section not shown (ignition switch). When the off signal is received, the vehicle is determined to be being parked. When the vehicle is not parked, no voltage is applied to the liquid crystal filters 531 to 536, thus keeping the filters in the light-transmitting state not to interrupt the vehicle running.

On the other hand, when the vehicle is being parked, it is determined whether or not the individual amount of solar radiation detected by each of the solar radiation sensors 521 to 526 exceeds the predetermined thresholds. When the amount of solar radiation is determined to exceed the threshold, the driving circuits 571 to 576 corresponding to the solar radiation sensors 521 to 526 detecting the solar radiation amounts for use in the determination apply the predetermined voltages to the liquid crystal filters 531 to 536, to be controlled. This brings the liquid crystal filters 531 to 536 into the light-shielded state. When the dimming glass control ECU 510 receives the on signal from the engine ignition operation section in this state, application of the voltages to all liquid crystal filters 531 to 536 is stopped, so that the filters 531 to 536 returns to the above-described light-transmitting state.

The liquid crystal filters 531 to 536 may be driven such that the higher the amounts of solar radiation detected by the solar radiation sensors 521 to 526, the higher the light shielding level.

Although in this embodiment the glare detection means corresponds to the solar radiation sensors 521 to 526, the invention is not limited thereto. The glare detection means may include means for obtaining the present time and position of the vehicle from a navigation device and for estimating (calculating) the sun position (including the azimuth thereof based on the time and position obtained. Alternatively, the glare detection means may include means for detecting the position of a head light of another vehicle or the presence or absence of lighting of the head light from a photographed image of a front visual field by a front visual field photographing camera.

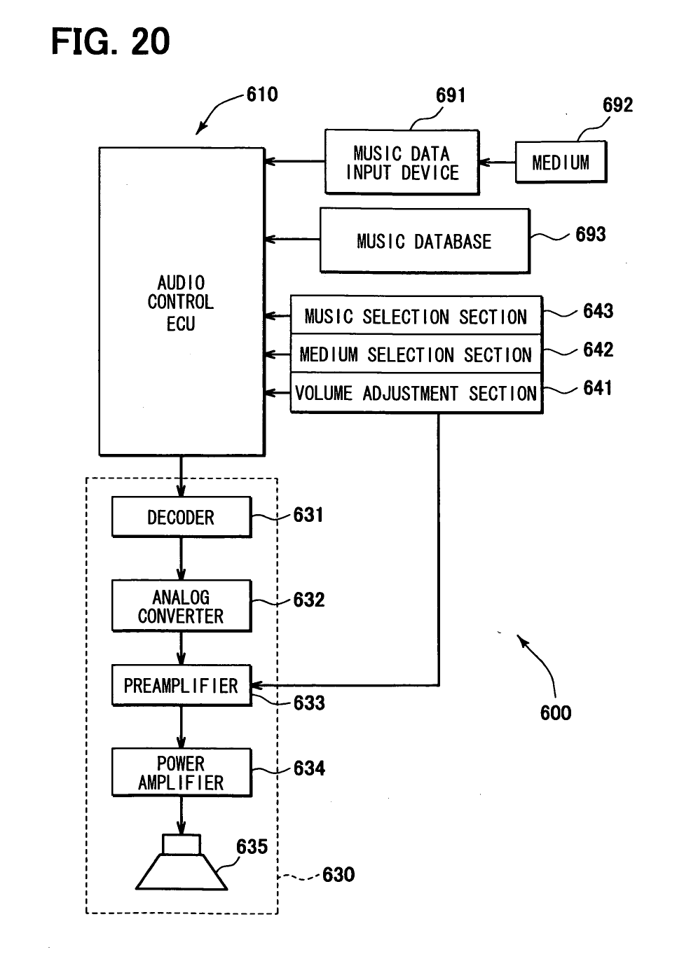

The audio control system 600 includes an audio control ECU 610, a driving section 630, and an operation section 640. The audio control ECU 610 has the well-known structure including the CPU, the ROM, the RAM, and the like. As shown in FIG. 20, the audio control ECU 610 is connected to a music data input device 691 for obtaining music source data from a predetermined medium (storage medium) 692, and a music database 693 serving an external storage device for storing therein the music source data. The operation section 640 is constructed as the well-known audio operation section, which includes a volume adjustment section 641, a medium selection section 642, a music selection section 643, and the like.

When a target music piece to be output is designated by the medium selection section 642 or the music selection section 643, the audio control ECU 610 reads the music source data including the designated music piece from the medium 692 or the music database 693 to output it to the driving section 630. The music source data is first decoded into digital music waveform data by the decoder 631 in the driving section 630. The digital music data is converted into analog form by an analog converter 632, and then output from a speaker 635 in a specified volume via a preamplifier 633 and a power amplifier 634.

The noise canceller control system 700 includes a noise canceller control ECU 710 having the well-known structure, including the CPU, the ROM, the RAM, and the like, and a driving section 730 for executing the function of the noise canceller and an operation section 740 which are connected to the ECU 710. The operation section 740 includes a noise canceller execution section for setting execution and stopping of the noise canceller function based on the user's operation.

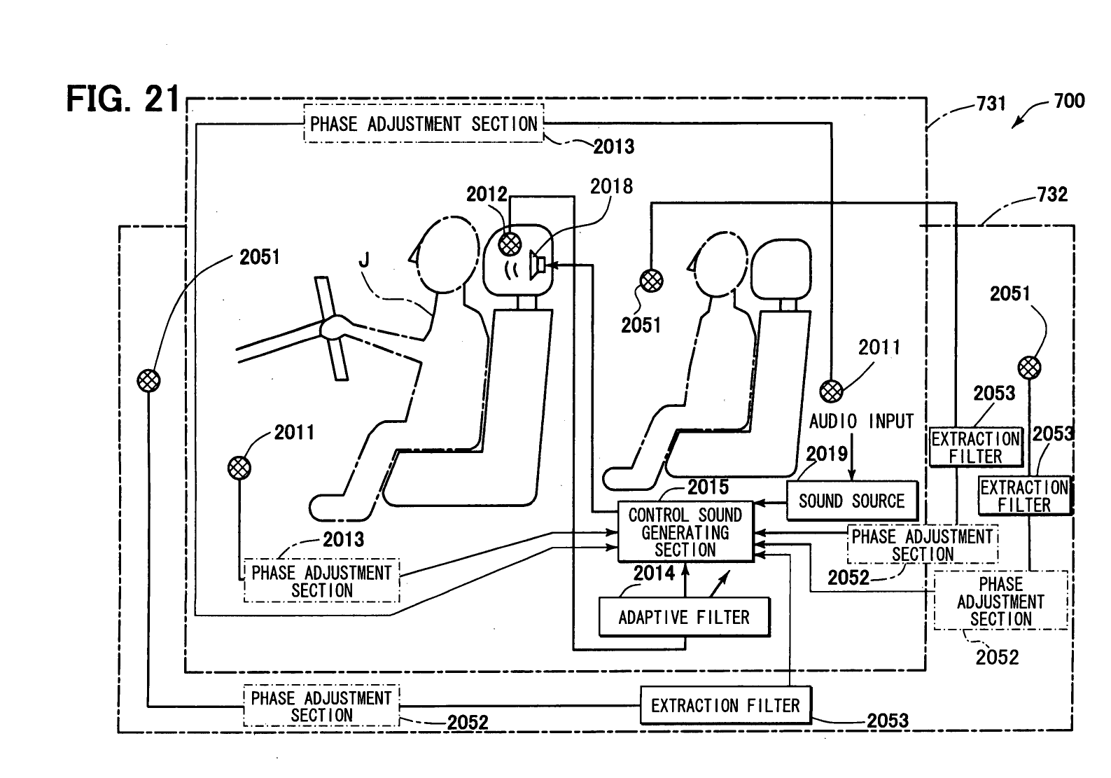

FIG. 21 is a functional block diagram showing an example of a construction of the noise canceller forming the driving section 730. The noise canceller 730 mainly includes an active noise control mechanism body 731 serving as noise reduction means, and a necessary sound emphasizing section (means) 732.

The active noise control mechanism 731 includes a vehicle interior noise detection microphone (noise detection microphone) 2011 for detecting noise entering the vehicle interior, and a waveform synthesizing section for control of the noise (control sound generating section) 2015 for synthesizing a noise waveform for control of the noise which has the opposite phase to the noise waveform detected by the vehicle interior noise detection microphone 2011. The waveform for control of the noise is output from a speaker 2018 for the noise control. The active noise control mechanism 731 is provided with an error detection microphone 2012 for detecting a noise component left after deleting and included in sound in the vehicle interior after superposition of an acoustic wave for the noise control. The active noise control mechanism 731 is also provided with an adaptive filter 2014 whose filter coefficient is adjusted so as to reduce the level of noise left after deletion.

The noise in the vehicle interior whose source is located in the vehicle itself may include an engine sound, a sound caused from a road surface, a wind noise, and the like. The vehicle interior noise detection microphones 2011 are distributedly arranged in positions appropriate for detection of the individual noise or sounds in the vehicle interior. Theses vehicle noise detection microphones 2011 are located in the different positions as viewed from the position of a passenger J. A considerable phase difference occurs between a noise waveform in the position of the microphone 211 and a noise waveform actually received by the passenger J. In order to include the phase difference, the detected waveform by the vehicle interior noise detection microphone 2011 is given to the control sound generating section 2015 via a phase adjustment section 2013 as appropriate.

The necessary sound emphasizing section 732 includes an emphasized sound detection microphone 2051 and a necessary sound extraction filter 2035. The extracted waveform of the necessary sound is given to the control sound generating section 2015. For the same reason as that of the vehicle interior noise detection microphone 2011, a phase adjustment section 2052 is provided as needed. The emphasized sound detection microphones 2051 are a microphone 2051 for the vehicle exterior adapted to taken in the necessary sound outside the vehicle, and a microphone 2051 for the vehicle interior adapted to take in the necessary sound inside the vehicle. Each of the microphones can be constructed of the well-known directional microphone. The microphone for the vehicle exterior is attached in such a manner that an angle area with strong directivity for sound detection is directed toward the vehicle exterior, while an angle area with weak directivity is directed toward the vehicle interior. Although in this embodiment, the entire of the vehicle exterior microphone 2051 is attached to appear outside the vehicle, the microphone 2051 can be attached to cross the border between the interior and exterior of the vehicle such that the angle area with the weak directivity is positioned inside the vehicle, while only the angle area with the strong directivity appears outside the vehicle. On the other hand, the vehicle interior microphone 2051 is attached in such a manner that an angle area with strong directivity for sound detection is directed to a front side of the passenger, while an angle area with weak directivity is directed in the opposite direction so as to selectively detect conversation sounds between the passengers for the respective seats. Each of the emphasized sound detection microphones 2051 is connected to a necessary sound extraction filter 2053 which allows a necessary sound component of the input waveform (detection waveform) to preferentially pass therethrough. The input of the car audio control system 600 shown in FIG. 1 is used as a sound source 2019 for a necessary sound in the vehicle interior. The output sound from a speaker in the audio device, in which the speaker may also serve as the noise control speaker 2018, or may be provided independently from the speaker 2018, is controlled such that it is not offset even when being superimposed on the waveform for the noise control.

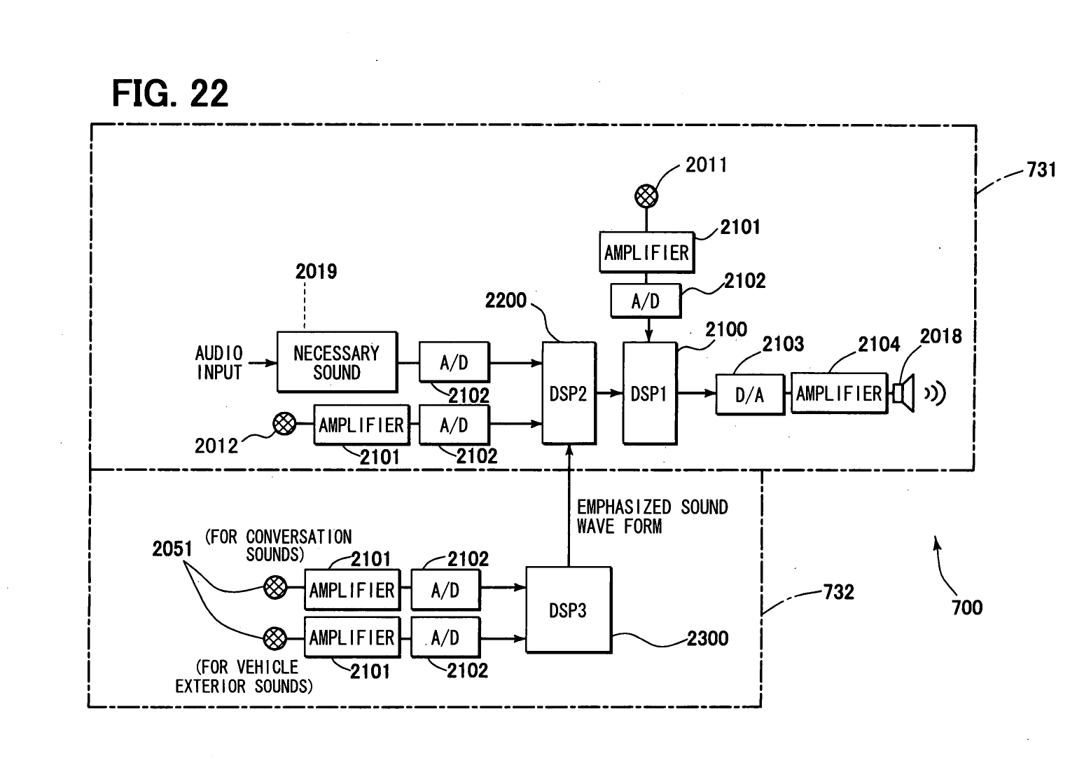

FIG. 22 shows an example of a hardware block diagram corresponding to the functional block diagram shown in FIG. 21. A first DSP (Digital Signal Processor DSP1) 2100 includes the waveform synthesizing section for the noise control (control sound generating section) 2015, the adaptive filter 2014 and the phase adjustment section 2013. The vehicle interior noise detection microphone 2011 is connected to the DSP 2100 via a microphone amplifier 2101 and an A/D converter 2102. The noise control speaker 2018 is connected to the DSP 2100 via a D/A converter 2103 and an amplifier 2104. On the other hand, a second DSP 2200 (DSP2) constitutes an extraction section of noise components to be reduced. The error detection microphone 2012 is connected to the DSP 2100 via the microphone amplifier 2101 and the A/D converter 2102. An audio signal source which is not an object to be reduced, such as an audio input, that is, the sound source 2019 for the necessary sound is connected to the DSP 2100 via the A/D converter 2102.

The necessary sound emphasizing section 732 includes a third DSP 2300 (DSP3) serving as the necessary sound extraction filter 2053. The necessary sound detection microphone (emphasized sound detection microphone) 2051 is connected to the DSP 2300 via the microphone amplifier 2102 and the A/D converter 2102. The third DSPO 2300 serves as a digital adaptive filter. Now, a setting procedure of a filter coefficient will be described below.

The following sounds are set as the necessary vehicle exterior sounds (emphasized sounds) to which attention should be paid, or which should be regarded as a dangerous state: siren sounds of an emergent vehicle (an ambulance, a fire engine, a police car, or the like), an alarm sound of a crossing plate, a horn sound of the following car, a whistle sound, and a scream of a person (for example, cry of a child, a scream of a woman, or the like). These sample sounds are stored in a disk or the like in the form of library as reference emphasized sound data which can be read and reproduced. Likewise, individual model sounds of persons are stored as the conversation sounds in the form of library as the reference emphasized data. When passengers on the vehicle are fixed, model sounds are prepared using voices of the passengers themselves as the reference emphasized sound data, so that the accuracy of emphasis of the conversation sounds can be enhanced when these passengers ride on the vehicle.

The filter coefficient has an appropriate initial value, and the emphasized sound detection level by the emphasized sound detection microphone 2051 is set to an initial value. Then, each reference emphasized sound is read and output, and detected by the emphasized sound detection microphone 2051. The waveform passing through the adaptive filter is read out, and the level of the waveform which can pass through the filter as the reference emphasized sound is measured. The above-described procedure will be repeatedly performed until the detected level reaches the target value. In this way, the reference emphasized sounds are in turn replaced for both of the vehicle exterior and interior sounds (conversation sounds), whereby the filter coefficient is learned such that the detected level of the passing waveform is optimized. The necessary sound is extracted from the input waveform from the emphasized sound detection microphone 2051 by use of the necessary sound extraction filter 2053 whose filter coefficient is adjusted as mentioned above. The emphasized sound waveform extracted is transferred from the third DSP 2300 to the second DSP 2200. The second DSP 2200 computes a difference by subtracting the input waveform from the sound source for the necessary sound (audio outputs) 2019 and the extracted emphasized sound waveform from the third DSP 2300, from the detected waveform by the vehicle interior noise detection microphone 2011.

The filter coefficient of the digital adaptive filter incorporated in the first DSP 2100 is initialized in advance of use of the system. Various kinds of noises to be reduced are first defined, and sample sounds thereof are recorded in the disk or the like in the form of library as the reproducible reference noise. The filter coefficient has an appropriate initial value, and the level of noise left after deletion by the error detection microphone 2012 is set to an initial value. Then, the reference noise is read and output in turn, and then detected by the vehicle interior noise detection microphone 2011. The detected waveform by the vehicle interior noise detection microphone 2011 which has passed through the adaptive filter is read out, and subjected to the high-velocity Fourier transform, so that the noise detection waveform is divided into sine constituent waves with difference wavelengths. A reverse constituent wave whose phase is reversed from that of each sine constituent wave is generated. These waves reversed are combined again to form a waveform for noise control whose phase is reversed from the noise detection waveform. This is output from the speaker 2018 for noise control.

When the coefficient of the adaptive filter is defined appropriately, only the driving component is effectively extracted from the waveform of the vehicle interior noise detection microphone 2011. The waveform for the noise control which is formed to have the reversed phase by the combination or synthesis based on the extracted component can offset the vehicle interior noise without excess or deficiency. However, when the filter coefficient is not set appropriately, the waveform component which is not offset is caused as the noise component left after deletion. This is detected by the error detection microphone 2012. The level of the noise component left after deletion is compared with the target value. When the level is not below the target value, the filter coefficient is updated. The same processing is repeatedly performed until the level becomes below the target value. In this way, the reference noise is replaced in turn, whereby the filter coefficient is learned such that the noise component left after deletion is minimized. In actual use, the noise component left after deletion is constantly monitored, and the filter coefficient is updated in real time such that the noise component is constantly minimized. And, the same processing is performed, so that only the noise level of the vehicle interior can be decreased effectively, while maintaining the necessary acoustic component.

The memory sheet control system 800 includes a memory sheet control ECU 810, and a sensor section 820, a driving section 830, and an operation section 840 which are connected to the ECU 810.

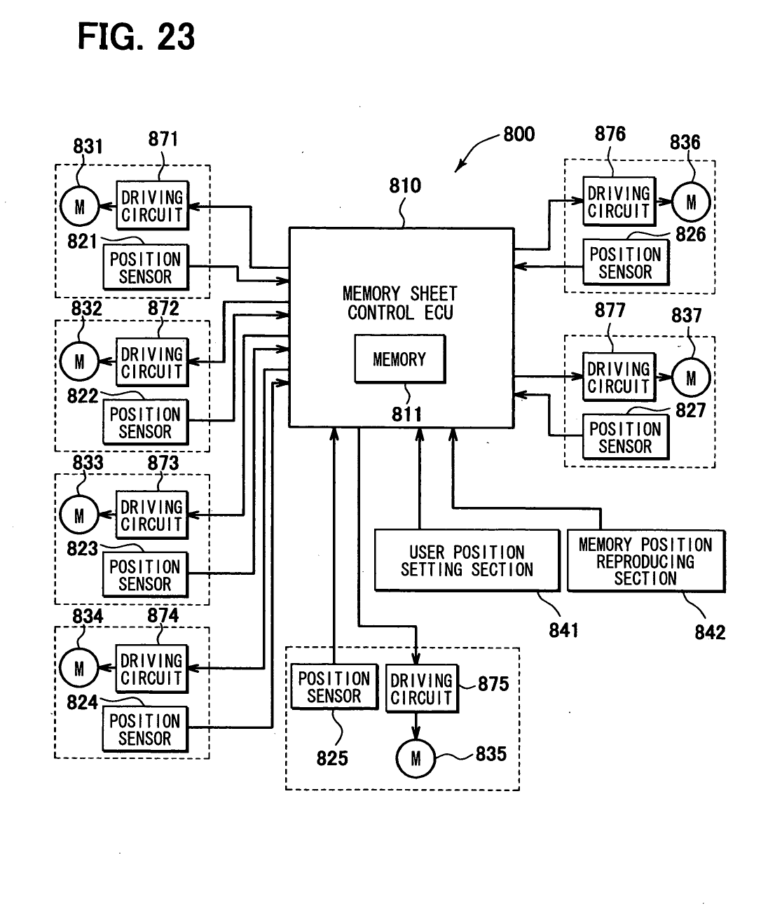

The memory sheet control ECU 810 has a structure including the CPU, the ROM, the RAM, and the like, and an external memory 811 serving as a nonvolatile memory (for example, which includes a flash memory, an EPROM, or the like, and which is hereinafter only abbreviated to a “memory 811”) as shown in FIG. 23. The memory 811 stores therein user position information about a relationship between the user and the driving position of the user.

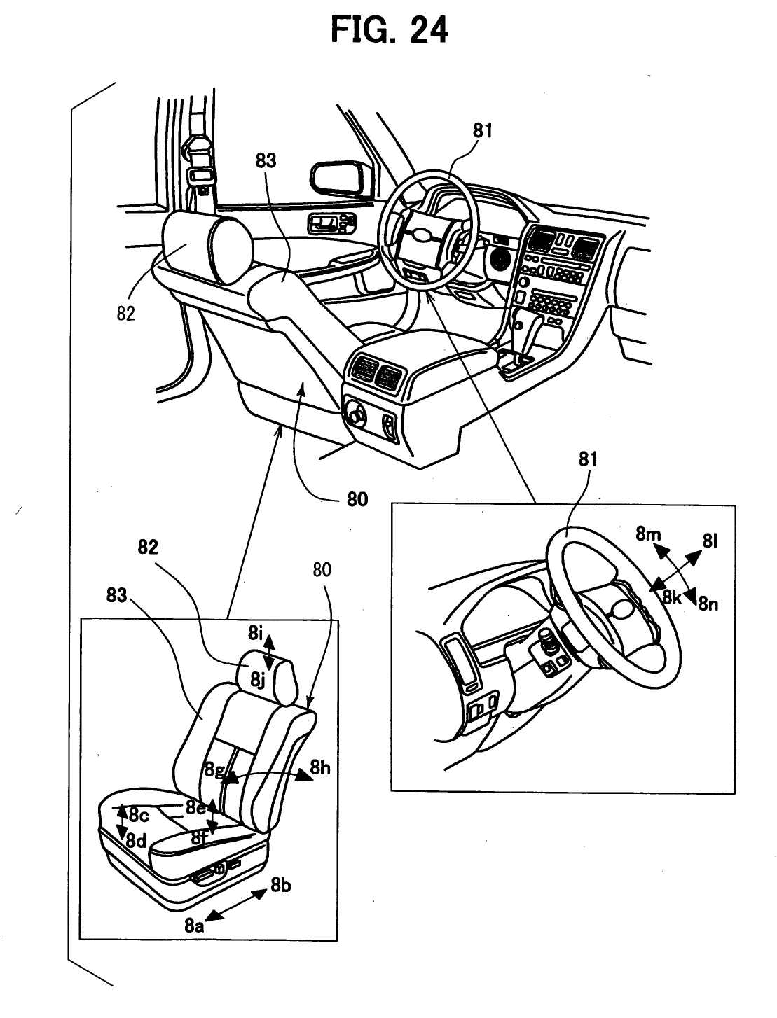

The driving position in this embodiment, as shown in FIG. 24, is defined by a front or back position of the driver seat 80 (a position in the direction indicated by the two-headed arrow 8a-8b), an upper or lower position of the front end of the driver seat 80 (a position in the direction indicated by the two-headed arrow 8c-8d), an upper or lower position of the rear end of the driver seat (a position in the direction indicated by the two-headed arrow 8e-8f), an inclined position on the front or back side of a reclining seat back 83 (a position in the direction indicated by the two-headed arrow 8g-8h), an upper or lower position of a head restraint 82 (a position in the direction indicated by the two-headed arrow 8i-8j), a front or back position of a steering wheel 81 (a position in the direction indicated by the two-headed arrow 8k-8l), and an upper or lower position of the steering wheel 81 (a position in the direction indicated by the two-headed arrow 8m-8n).

The driving section 830 includes a motor 831 for forward and backward driving of the driver seat which is adapted to drive the driver seat 80 in the front or back direction (in the direction indicated by the two-headed arrow 8a-8b), and a motor 832 for upward and downward driving of the front end of the driver seat which is adapted to drive the front end of the driver seat 80 in the upper or lower direction (in the direction indicated by the two-headed arrow 8c-8d). The driving section 830 also includes a motor 833 for upward and downward driving of the rear end of the driver seat which is adapted to drive the rear end of the driver seat 80 in the upper or lower direction (in the direction indicated by the two-headed arrow 8e-8f), and a motor 834 for driving the reclining seat which is adapted to incline the seat back 83 in the front or back direction (in the direction indicated by the two-headed arrow 8g-8h). The driving section 830 further includes a motor 835 for upward and downward driving of the head restraint which is adapted to drive the head restraint 82 in the upper or lower direction (in the direction indicated by the two-headed arrow 8i-8j), and a motor 836 for forward and backward driving of the steering wheel which is adapted to drive the steering wheel 81 in the front or back direction (in the direction indicated by the two-headed arrow 8k-8l). The driving section 830 still further includes a motor 837 for upward and downward driving of the steering wheel which is adapted to incline the steering wheel 81 in the upward or downward direction (in the direction indicated by the two-headed arrow 8m-8n), and driving circuits 871 to 877 corresponding to the respective motors 831 to 837.

The sensor section 820 is constructed of the well-known position detection sensors (position sensors). The sensor section 820 includes a driver seat front and back position sensor 821 for detecting the front or back position of the driver seat 80 (the position in the direction indicated by the two-headed arrow 8a-8b), and a driver-seat front-end upper and lower position sensor 822 for detecting the upper or lower position of the front end of the driver seat 80 (the position in the direction indicated by the two-headed arrow 8c-8d). The sensor section 820 also includes a driver-seat rear-end upper and lower position sensor 823 for detecting the upper or lower position of the rear end of the driver seat 80 (the position in the direction indicated by the two-headed arrow 8e-8f. The sensor section 820 further includes a reclining position sensor 824 for detecting the inclined front and back positions of the seat back 83 (the position in the direction indicated by the two-headed arrow 8g-8h), and a head restraint upper and lower position sensors 825 for detecting the upper or lower position of the head restraint 82 (the position in the direction indicated by the two-headed arrow 8i-8j). The sensor section 820 still further includes a steering wheel front and back position sensor 826 for detecting the front or back position of the steering wheel 81 (the position in the direction indicated by the two-headed arrow 8k-8l), and a steering wheel upper and lower position sensor 827 for detecting the upper or lower position of the steering wheel 81 (the position in the direction indicated by the two-headed arrow 8m-8n).

The operation section 840 adjusts the driving positions 8a to 8n based on the designation of a user by the user's operation. The operation section 840 includes a user position setting section 841 for storing the adjusted position in the memory 811 as the user position information, and a memory position reproducing section 842. The memory position reproducing section 842 includes a user designating section for designating the user from among the registered users, and a reproduction execution section for driving the driving section 830 so as to take the driving position based on the position information about the designated user.

When the memory position reproducing section 842 is operated, the memory sheet control ECU 810 reads out the user position information about the designated user from the memory 811, and drives the driving section 830 (driving sections 831 to 837) based on the user position information read. This reproduces the driving position set by the user designated.

The driving sections 130, 230, 330, 430, 530, 630, 730, 830 of the low-level control systems 100, 200, 300, 400, 500, 700, 800 as mentioned above serve as the environment adjustment section of the invention.

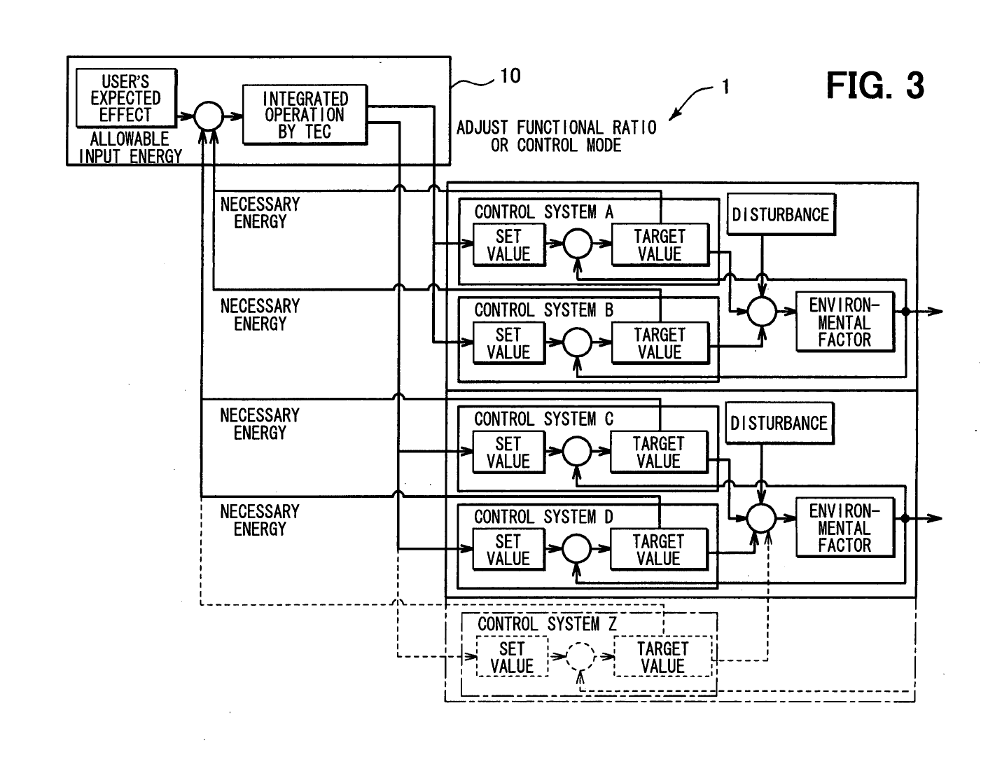

As shown in FIG. 1, in the vehicle interior environment control system 1 of this embodiment, the above-described control systems 100 to 800 serve as the low-level control system, and the vehicle interior environment integrated system (integrated control means) 10 is provided as the control system positioned on the upper level. These low-level control systems 100 to 800 are entirely structured as shown in FIG. 3 such that these systems can execute the above-described self functions independently.

FIG. 3 is a block diagram showing an entire configuration of the vehicle interior environment control system 1 in this embodiment. The control systems A to D shown in FIG. 3 correspond to the above-described low-level control systems 100 to 800. Each of these systems A to D is adapted to compare a present detected value of the vehicle interior environmental control factor to be controlled with the target value, and performs feedback control of a control amount (target control amount) of interest based on the comparison result such that the present detected value is close to the target value. The main bodies (low-level control main bodies) for executing the feedback control are the ECUs 110 to 810 including the low-level control systems 100 to 800.

Upon independently receiving inputs of the target control amounts from the low-level control systems A to D, the upper-level vehicle interior environment integrated system 10 is involved in execution of the low-level control systems A to D in such a manner as to adjust set values (control modes or target values) of the low-level control systems A to D based on the target control amounts.

That is, the upper-level vehicle interior environment integrated system 10 obtains the target control amounts from the low-level control systems A to D, and the low-level control systems A to D simply adjust the set values which are set by the respective control systems. Thus, when the upper-level vehicle interior environment integrated system 10 does not exist, the low-level control systems A to D (100 to 800) are configured to independently exhibit the functions thereof by determining the set values by themselves. This facilitates new incorporation of another control system which can function individually (for example, the control system Z shown in FIG. 3) as the low-level control system of the vehicle interior environment integrated system 10, like the above-described low-level control systems A to D.

The vehicle interior environment integrated system 10 directs and manages the respective low-level control systems 100 to 800. As shown in FIG. 2, the integrated system 10 serving as a controller includes a CPU 11, a RAM 12 including a work memory, a ROM 13 for storing therein various kinds of programs, a bus line 14, and an I/O 15 serving as an input/output circuit. The integrated system 10 also includes an external memory 16 which is a nonvolatile memory (for example, which includes a flash memory, an EPROM, or the like, and which is hereinafter only abbreviated to a “memory 811”), and a communication interface (which is displayed as “I/F” in the figure) 17 connected to the vehicle interior LAN 50.

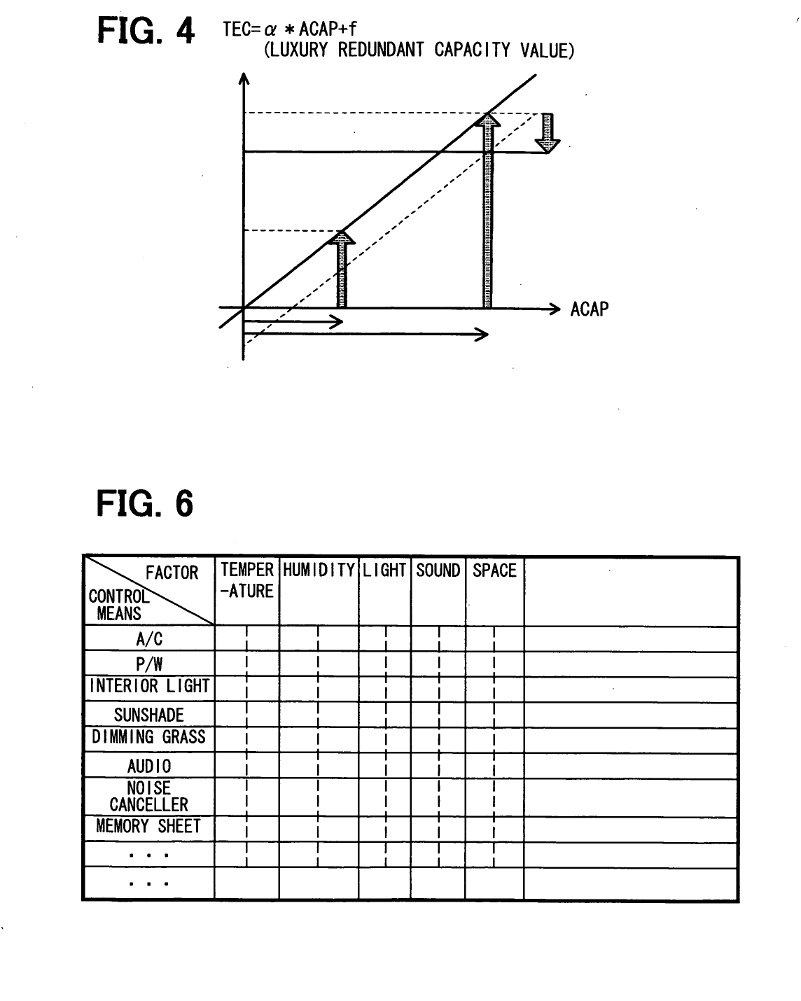

The I/O 15 of the vehicle interior environment integrated system 10 is connected to an environmental luxury degree setting section (input means of an environmental luxury degree) 2 which changeably inputs a user's desired environmental luxury degree ACAP with respect to a vehicle interior integrated environmental adjusted state achieved by the cooperation among the low-level control systems 100 to 800. The vehicle interior environment integrated system 10 sets the environmental luxury degree ACAP based on the input state, as shown in FIG. 4. The environmental luxury degree setting section 2 is operated by receiving an input from the user in the vehicle compartment, and the environmental luxury degree ACAP is constructed of a lever which can be set in multiple stages. In this embodiment, the environmental luxury degree ACAP can be switched among ten stages from the minimum “1” to the maximum “10” by a lever operation of the environmental luxury degree setting section 2.

The environmental luxury degree ACAP is a parameter indicative of “the degree of hospitality” expected by the user and which reflects the level of the user's expected effect for the interior environment adjustment. The vehicle interior environment integrated system 10 is adapted to control communication among the low-level control systems such that as the environmental luxury degree input becomes higher, the low-level control system having a higher grade of capacity is preferentially operated.

Grading the capacity of each of the low-level control systems 100 to 800 is set using a grading parameter indicative of a capacity grade. The system having a greater amount of resource (consumed energy of each control system, or consumed energy of an integrated infrastructure) introduced for the total environmental adjustment state of the vehicle interior is set to be highly graded. Alternatively, the system in which the user's operation amount for executing the environment adjustment of the vehicle interior is small is highly graded. Thus, as the environmental luxury degree ACAP input and set becomes higher, the user's desired vehicle interior environmental state can be obtained without any means given by the user. And, the low-level control systems including a control system which needs high controllability are selected so as to quickly reach to the user's desired vehicle interior environmental state. The so-called luxurious control is executed in the vehicle chamber. In contrast, as the environmental luxury degree ACAP becomes small, only the low-level control system having a low capacity grade can be selected for purpose of adjusting the vehicle interior environment, as shown in FIG. 4. Thus, it takes much time until the user's desired indoor state is reached, and in some cases, the user's desired indoor environmental state is not reached, but is approached. In order to change this situation, control is performed which puts an enormous load on the user, for example, which requires a manual operation of each control system by the user.

The grading parameter in this embodiment is a required capacity value fn for optimizing the vehicle interior environment, which value is set one by one corresponding to the driving sections 130 to 830 of the low-level control systems 100 to 800. The grading parameter is a parameter obtained by the vehicle-interior environment integrated system 10 from each of the low-level control systems 100 to 800. Each of the low-level control systems 100 to 800 updates the required capacity value fn based on the set value of the control amount thereof according to the set value of the feedback control. The updated required capacity value fn is output and fed back to the vehicle interior environment integrated system 10 which is the upper-level control system.

That is, each of the low-level control systems 100 to 800 acts as grading parameter setting means, required capacity value setting means, and required capacity value outputting means according to the invention. In this embodiment, since the required capacity value fn also serves as the grading parameter, one of the driving sections 130 to 830 having the larger required capacity value fn set among the low-level control systems 100 to 800 is defined as positioned on the upper level of the capacity grading. The required capacity value fn is set as a numerical value parameter directly comparable among the low-level control systems for each environmental factor.

In the vehicle interior environment integrated system 10 which is the upper-level control system, the required capacity values fns fed back and input from the respective low-level control systems 100 to 800 are integrated and computed according to the pre-set computation procedure to compute the integrated required capacity value Σfn. Further, a total luxury-degree-reflecting capacity value which is a numerical value parameter directly comparable with the above-described required capacity value fn is calculated based on the set value of the environmental luxury degree ACAP set by the environmental luxury degree setting section 2 being in an input state.

By comparing the thus-obtained integrated required capacity value Σfn with the total luxury-degree-reflecting capacity value, the cooperation between the environment adjustment sections is controlled such that as the integrated required capacity value Σfn is closer to the total luxury-degree-reflecting capacity value, the environment adjustment section having the lower capacity grade is preferentially performed. Specifically, a luxury redundant capacity value TEC represented by a difference between the total luxury-degree-reflecting capacity value and the integrated required capacity value Σfn is computed. One of the driving sections 130 to 830 is selected for operation based on the result of the comparison between the luxury redundant capacity value TEC with the integrated required capacity value Σfn from each of the low-level control systems 100 to 800.

That is, the vehicle interior environment integrated system 10 serves as total luxury-degree-reflecting capacity value calculation means, integrated required capacity value computation means, capacity value comparison means (luxury redundant capacity value computation means), and environment adjustment section selecting means according to the invention.

In the vehicle interior environment integrated system 10, system selection control is executed to select the low-level control system in this way. The system selection control includes first selection control for selecting a control system such that the energy is optimized for each environmental factor, and second selection control for selecting a control system such that the energy is optimized for the entire environmental factors in this embodiment. Either selection control may be used. In this embodiment, the first selection control is performed.

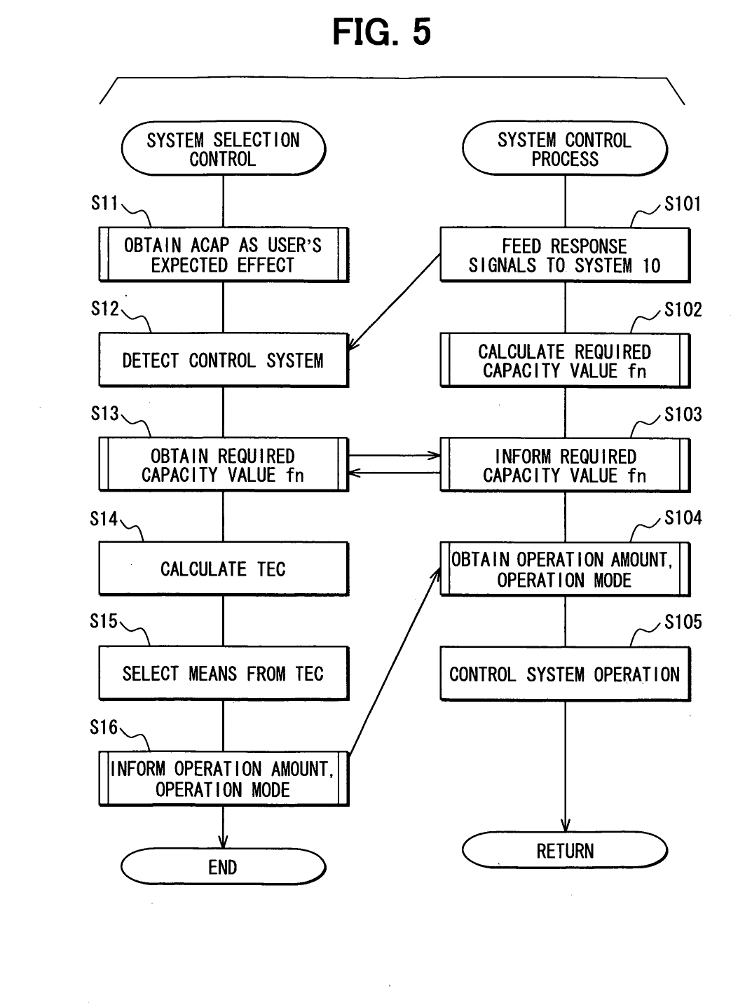

Now, the above-described first selection control will be described below using the flowchart of FIG. 5. First, in step S11, an environmental luxury degree ACAP set at the present time is obtained as an expected effect desired by the user for the total environmental adjusting state in the vehicle interior.

Subsequently, in step S12, the low-level control system for controlling each environmental factor is detected. The environmental factors specifying the vehicle interior environment are previously defined as shown in the table about the environmental factors in FIG. 6. The low-level control system is detected which feeds the output to have an influence on the environmental factors defined. Specifically, this is determined based on whether a search response signal exists or not for a low-level control system search signal fed from the vehicle interior environment integrated system 10. The control systems 100 to 800 feed the response signals to the vehicle interior environment integrated system 10 for the low-level control system search signals (step S101). Thus, columns for control means of the table shown in FIG. 6 made on the RAM 12 of the vehicle interior environment integrated system 10 are defined.

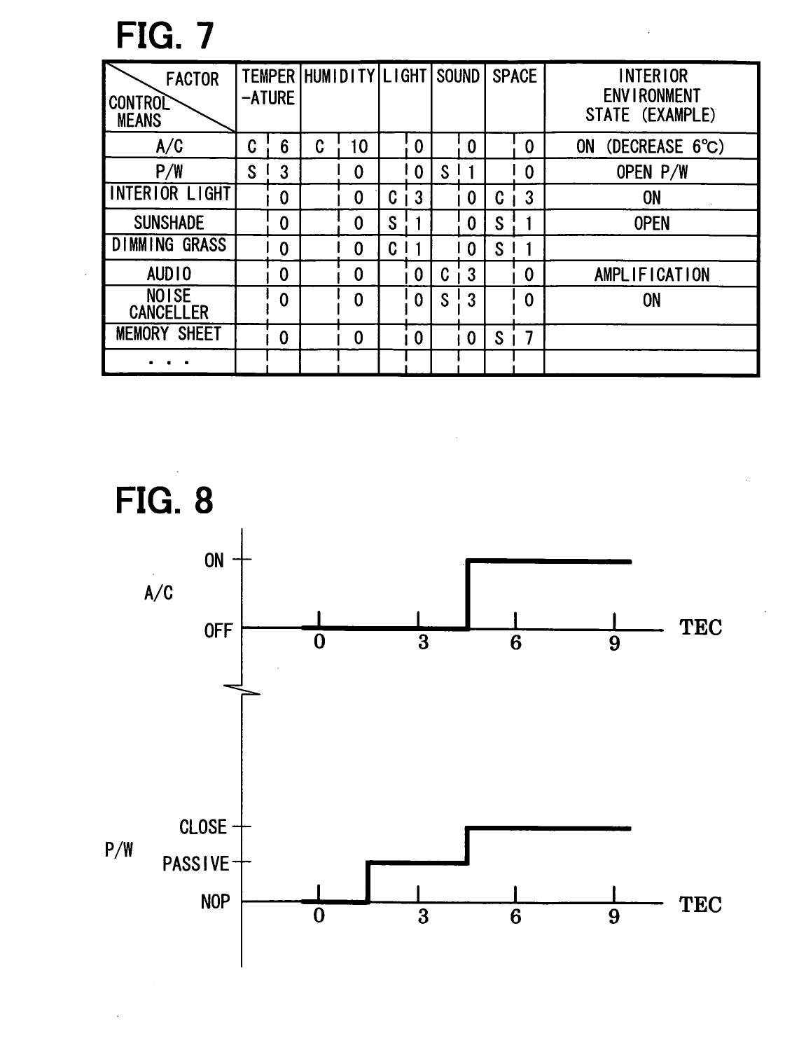

In step S13, an amount of control set in each of the low-level control systems 100 to 800 (target control amount) is obtained. Specifically, the required capacity value fn is obtained based on the set value of the control amount. Each of the ECUs 110 to 810 of the low-level control systems 100 to 800 calculate the required capacity value fn for each environmental factor based on the control amount updated by itself (step S102), and then returns and informs the required capacity value fn to the vehicle interior environment integrated system 10 (step S103). The vehicle interior environment integrated system 10 receives and obtains the value fn. That is, the required capacity value fn is a capacity value of each of the driving sections 130 to 830 set by each of the low-level control systems 100 to 800 at that time, and then fed back to the vehicle interior environment integrated system 10. Thus, for example, values are set, for example, in the form as shown in FIG. 7, in the input columns for the capacity values of the control means corresponding to the respective environmental factors shown in the table of FIG. 6.

Each of the driving sections 130 to 830 of the low-level control systems 100 to 800 includes either an active operation section or a passive operation section. The active operation section is adapted to operate so as to offset disturbance from the vehicle exterior which may keep the vehicle interior environmental factor of interest away from the target value, by positively introducing the energy. The passive operation section is adapted to operate so as to prevent the disturbance from entering the vehicle interior in the same manner, or so as to use disturbance acting in such a direction to put the vehicle interior environmental factor of interest closer to the target value. That is, the required capacity value fn of the active operation section means a consumption capacity value for controlling each environmental factor by active introduction of the resource of the vehicle interior. The required capacity value fn of the passive operation section means a saving capacity value for controlling each environmental factor by introduction of the external resource.

The ECU for controlling the driving section serving as the passive operation section detects the present vehicle interior value of the vehicle environmental factor by the sensor, and compares the present vehicle interior value with a vehicle exterior disturbance value and the target value corresponding thereto. The ECU controls the operation of the passive operation section based on the comparison result. Specifically, the ECU controls the operation of the corresponding driving section so as to use the disturbance when a difference determined by subtracting the target value from the present vehicle interior value has the same sign as that of a difference determined by subtracting the vehicle exterior disturbance value from the present vehicle interior value. Likewise, the ECU controls the operation of the corresponding driving section so as to interrupt the disturbance when the former difference has the opposite sign to the latter difference. The ECU for controlling the passive operation section serves as disturbance comparison means and passive operation section control means according to the invention.

Thus, in calculation of the integrated required capacity value Σfn, the active operation section contributes to increase the integrated required capacity value Σfn, and the passive operation section contributes to decrease the integrated required capacity value Σfn. That is, the required capacity values fns of both operation sections are set in the table of FIG. 6 (FIG. 7) so as to have the opposite signs to each other. Note that all of the required capacity value fn, the integrated required capacity value Σfn, and the luxury redundant capacity value TEC are defined as those having the same dimension for each environmental factor.

In step S14, the luxury redundant capacity value TEC is calculated for each environmental factor. In order to calculate the luxury redundant capacity value TEC, first, the vehicle interior environment integrated system 10 calculates a total luxury-degree-reflecting capacity value for each environmental factor based on the environmental luxury degree ACAP obtained in step S11. Then, referring to the table shown in FIG. 6, the required capacity values fns are added up and integrated for each environmental factor thereby to compute the integrated required capacity value Σfn of each environmental factor. The luxury redundant capacity value TEC is calculated from the difference between the thus-obtained total luxury-degree-reflecting capacity value and the integrated required capacity value Σfn.

Now, the calculation of the luxury redundant capacity value TEC will be described specifically. The TEC of each environmental factor can be calculated, for example, by substitution into the following formula 1.

TEC=α×ACAP+β×Σfn (Formula 1)

The total luxury-degree-reflecting capacity value is a value defined by multiplying the environmental luxury degree ACAP by a positive coefficient α determined for each environmental factor in order to be converted into a numerical value parameter directly comparable with each required capacity value fn. The coefficient β is a negative coefficient in order to separate the vehicle interior from the exterior thereof when adverse affect from the exterior (+: capacity introduction) is strong, or in order to open the interior and exterior of the vehicle when good influence from the exterior (−: capacity recovery) is expected. That is, the β is defined so as to contribute to a decrease in luxury redundant capacity value TEC in the active operation section, and to an increase in the TEC in the passive operation section. The term “n” satisfies the following relation: n=1 to i (wherein is the total number of the low-level control systems).

The table for calculation of the luxury redundant capacity value TEC is made as shown in FIG. 7, wherein α=3, and β=−1.2 are set. When ACAP=4, the TEC for each environmental factor is set as follows:

Temperature TEC=(+3)×4+(−1.2)×{(+6)+(−3)}=8.4

Humidity TEC=(+3)×4+(−1.2)×(+10)=0

Light TEC=(+3)×4+(−1.2)×{(+3)+(−1)+(+1)}=8.4

Sound TEC=(+3)×4+(−1.2)×{(−1)+(+3)+(−3)}=13.2

Space TEC=(+3)×4+(−1.2)×{(+3)+(−1)+(−1)+(−7)}=19.2

When the total luxury-degree-reflecting capacity value is changed with the change in environmental luxury degree ACAP by the operation of the environmental luxury degree setting section 2, the luxury redundant capacity value TEC is also changed. In this embodiment, when, for example, the required capacity value fn is obtained as shown in FIG. 7 and the environmental luxury degree ACAP is in a range from 1 to 4, the luxury redundant capacity value TEC of the temperature is as follows.

In the case of ACAP=4,

Temperature TEC=(+3)×4+(−1.2)×{(+6)+(−3)}=8.4

In the case of ACAP=3,

Temperature TEC=(+3)×3+(−1.2)×{(+6)+(−3)}=5.4

In the case of ACAP=2,

Temperature TEC=(+3)×2+(−1.2)×{(+6)+(−3)}=2.4

In the case of ACAP=1,

Temperature TEC=(+3)×1+(−1.2)×{(+6)+(−3)}=0.6

When the luxury redundant capacity value TEC of each environmental factor is calculated in step S14, the low-level control system to be used for control of each environmental factor is selected in a way to be described later. In step S16, an amount of operation, an operation mode, or the like is informed to the low-level control system selected. Then, the amount of operation or the operation mode is input to step S104 of FIG. 5 from step S16, and the low-level control systems 100 to 800 controls itself system operation based on the obtained instruction at step S105.

Now, the selection of the low-level control system in step S15 will be described below. The selection of the low-level control system can be performed using any one of the following two methods. In this example, the temperature is defined as the environmental factor. Each selection method will be described below.

When the environmental factor is the temperature, the target value is defined in the form of the temperature of the vehicle interior, and set by a temperature setting section 126. The present temperature of the vehicle interior is detected by the inside air temperature sensor 121, and the disturbance value is the vehicle exterior temperature detected by the outside air temperature sensor 122.

When the environmental factor is temperature, the active operation section is the driving section 130 of the air conditioning control system 100 (air conditioning control section 100U: vehicle indoor air conditioner of the invention), and the passive operation section is the power window driving section (power window mechanism) 230 of the power window control system 200. The power window driving section which is the passive operation section controls the temperature which is the environmental factor in the following way. When the vehicle interior temperature is lower than the target temperature and the vehicle exterior temperature is higher than the vehicle interior temperature, or when the vehicle interior temperature is higher than the target temperature and the vehicle exterior temperature is lower than the vehicle interior temperature, the power window driving section operates in the direction to open the window. When the vehicle interior temperature is lower than the target temperature and the vehicle exterior temperature is lower than the vehicle interior temperature, or when the vehicle interior temperature is higher than the target temperature and the vehicle exterior temperature is higher than the vehicle interior temperature, the power window driving section operates in the direction to shield (close) the window.

The first selection method involves previously storing a selection pattern of each control system corresponding to the luxury redundant capacity value TEC, and selecting the control system with reference to the selection pattern. This embodiment refers to the selection patterns shown in FIG. 8. In this case, when the environmental luxury degree ACAP is set in the range of 1 to 4 as mentioned above, for example, the temperature TEC has the following value.

### (In the Case of ACAP=4)

This case corresponds to TEC=8.4. Thus, the air conditioning section 100U (hereinafter referred to as an A/C) and a power window (hereinafter referred to as a P/W) are selected. In this case, the P/W is driven toward the closed position, so that all windowpanes remain in the closed state.

### (In the Case of ACAP=3)

This case corresponds to TEC=5.4. Thus, the A/C and P/W are selected. In this case, the P/W executes passive driving, which involves normally remaining the closed state of the windowpanes, instantly bringing the windowpane into the open state at pre-set timing (for example, at timing when the vehicle interior temperature exceeds the set temperature by one degree), and keeping it in the open state only for a predetermined time to take in the outside air.

### (In the Case of ACAP=2)

This case corresponds to TEC=2.4. Thus, only the P/W is selected. In this case, the P/W also executes the passive driving as mentioned above.

### (In the case of ACAP=1)

This case corresponds to TEC=−0.6. Thus, none of the A/C and P/W is selected (NOP). The user needs to manually open the P/W or decrease the set temperature of the A/C when intending to change the temperature.

In this case, since the selection patterns shown in FIG. 8 are used to select not only the control system, but also the contents of control, in step S16 of FIG. 5, the set value is adjusted such that the driving section of each of the control systems 100 to 800 is driven according to the control contents selected based on the selection pattern shown in FIG. 8.

The second selection method involves preferentially selecting the low-level control system having the low controllability rather than the low-level control system having the high controllability.

Specifically, the selection is performed in the following way. When the luxury redundant capacity value TEC exceeds the integrated required capacity value Σfn, all driving sections of the low-level control systems are selected as the operable driving section. When the luxury redundant capacity value TEC is below the integrated required capacity value Σfn, the driving section having the smaller required capacity value is preferentially selected in order to maximize the luxury redundant capacity value TEC in a range below the integrated required capacity value Σfn. The preference order is defined to perform the selection such that the integrated required capacity value is maximized in the form to exclude one or more driving sections positioned on the upper level of a rank order of the required capacity values. The passive operation section is preferentially defined rather than the active operation section.

When the luxury redundant capacity value TEC is below the integrated capacity value Σfn while the driving sections in operational selection include both of the active operation section and the passive operation section, at least a part of the active operation section in the operational selection is excluded from the selection of the driving section. When the luxury redundant capacity value TEC is zero or a negative value while the driving sections in operational selection include both of the active operation section and the passive operation section, all driving sections in the operational selection are excluded from the selection of the driving section, and thus only the passive operating section is selected to be operated. When the luxury redundant capacity value TEC is recovered to a predetermined level on the positive value side while only the passive operation section is selected to be operated, at least a part of the active operation section in which the luxury redundant capacity value has been selectively excluded in the range not falling below the integrated capacity value is then recovered and selected.

After the selection, notification (command) of an amount of operation, an operation mode, or the like is given to each selected control system such that the capacity can be exhibited based on each required capacity value fn (see FIG. 7). Even when the low-level control system not selected has the required capacity value fn that can put each environmental factor closer to the target value, a notification (command) for prohibiting the exhibition of the capacity is given. For example, when the environmental luxury degree ACAP is set in a range of 1 to 4, the temperature TEC has the following value.

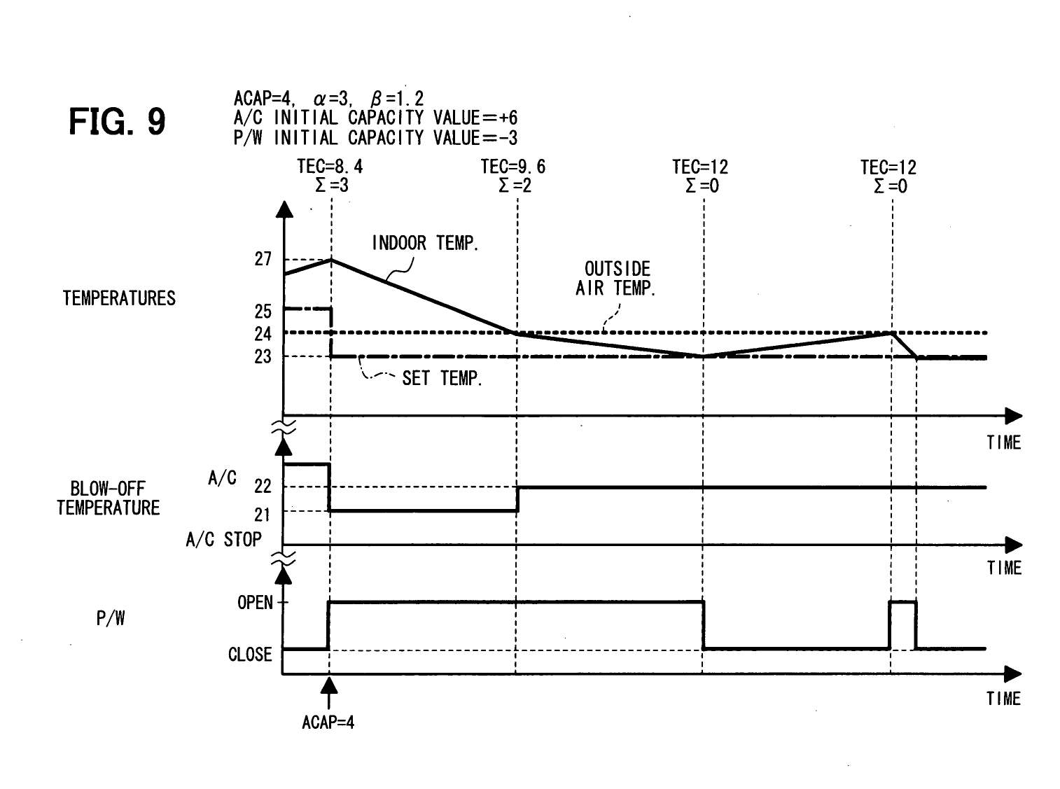

### (In the case of ACAP=4: see FIG. 9)

The initial state is a state in which the outside air temperature is 24 degrees, the indoor temperature is 27 degrees, and the set temperature decreases from 25 degrees to 23 degrees.

At this time, the required capacity values fns of the A/C and P/W are as follows, as shown in FIG. 7: the A/C has the capacity value of 6 (consumption capacity value), and the P/W has the capacity value of 3 (saving capacity value). In FIG. 7, “C” indicates the consumption capacity value, and “S” indicates the saving capacity value. The capacity value (consumption capacity value) of 6 for the A/C means a capacity value when an air blow-off temperature is 21 degrees as the appropriate one in order to decrease the indoor temperature from 27 degrees to 23 degrees at the outside air temperature of 24 degrees. The capacity value (saving capacity value) of 3 of the P/W means a capacity value for decreasing the indoor temperature from 27 degrees to 24 degrees by bringing the P/W into an open state to receive the introduction of the capacity from an outside resource, and by saving the consumption capacity value by three.

The TEC and Σfn in this case are calculated in the following way.

TEC=(+3)×4+(−1.2)×{(+6)+(−3)}=8.4

Σfn=(+6: A/C capacity value)+(−3: P/W capacity value)=3

Since the TEC exceeds the Σfn, both control systems are selected. The vehicle interior environment integrated system 10 instructs the A/C to perform introduction of the capacity of six (setting the blow-off temperature to 21 degrees), and the P/W to perform recovering of the capacity of three (driving the P/W toward an open state and maintaining the open state of the P/W).

Then, the outside air temperature is 24 degrees, the indoor temperature is decreased from 27 degrees to 24 degrees to be saturated, and the set temperature remains at 23 degrees.

At this time, the required capacity values fns of the A/C and P/W are as follows. The A/C has the capacity value of 2 (consumption capacity value: a capacity value when setting the appropriate blow-off temperature to 22 degrees (which is increased by one degree from 21 degrees due to overshoot and reduction) in order to decrease the indoor temperature from 24 degrees to 23 degrees at the outside air temperature of 24 degrees). The P/W has the capacity value of 0 (zero) (which means that the indoor temperature of 24 degrees cannot be decreased even when receiving the introduction of the capacity from the outside resource while the P/W is in the open state).

The TEC and Σfn in this case are calculated in the following way.

TEC=(+3)×4+(−1.2)×{(+2)+(0)}=9.6

Σfn=(+2: A/C capacity value)+(0: P/W capacity value)=2

Since the TEC exceeds the Σfn, both control systems are selected. However, the capacity value of the P/W is zero (0), and thus the actually driven system is only the A/C. The vehicle interior environment integrated system 10 instructs the A/C to perform introduction of the capacity of 2 (setting the blow-off temperature to 22 degrees), and the P/W to perform recovering of the capacity of 0 (that is, not to drive the P/W, while maintaining the open state of the P/W).

Furthermore, the outside air temperature is 24 degrees, the indoor temperature is decreased from 24 degrees to 23 degrees, and the set temperature remains at 23 degrees.

At this time, the required capacity values fns of the A/C and P/W are as follows. The A/C has the capacity value of 1 (consumption capacity value: a capacity value for continuing to set the blow-off temperature to 22 degrees in order to maintain the indoor temperature of 23 degrees at the outside air temperature of 24 degrees). The P/W has the capacity value of 1 (saving capacity value: which is a capacity value for interrupting the introduction of the capacity by one degree from the outside resource by shifting the P/W from the open state to the closed state).

The TEC and Σfn in this case are calculated in the following way.

TEC=(+3)×4+(−1.2)×{(+1)+(−1)}=12

Σfn=(+1: A/C capacity value)+(−1: P/W capacity value)=0

Since the TEC exceeds the Σfn, both control systems are selected. The vehicle interior environment integrated system 10 instructs the A/C to perform introduction of the capacity of 1 (setting and keeping the blow-off temperature at 22 degrees), and the P/W to perform recovering of the capacity of 1 (driving the P/W toward the closed state and maintaining the closed state of the P/W).

The outside air temperature, the indoor temperature, and the set temperature remain at 24 degrees, 23 degrees, and 23 degrees, respectively.

Since the TEC and the Σfn do not change, both control systems are selected. The A/C constantly functions actively, and the P/W remains in the closed state. It is noted that when the temperature falls below 23 degrees while the relation of TEC=12 is maintained, the P/W is driven passively (normally maintained in the closed state, but brought into and kept in the open state only for a predetermined time).

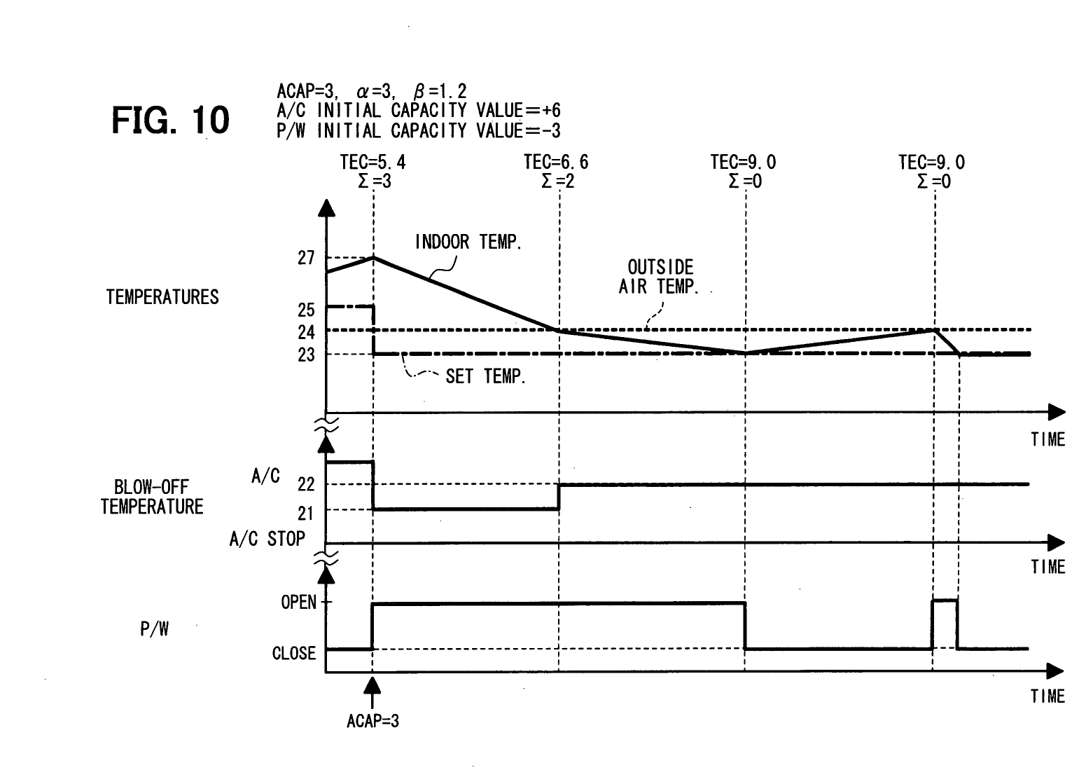

### (In the Case of ACAP=3: See FIG. 10)

The initial state is a state in which the outside air temperature is 24 degrees, the indoor temperature is 27 degrees, and the set temperature decreases from 25 degrees to 23 degrees.

At this time, the required capacity values fns of the A/C and P/W are as follows, as shown in FIG. 7: the A/C has the capacity value of 6 (consumption capacity value), and the P/W has the capacity value of 3 (saving capacity value).

The TEC and Σfn in this case are calculated in the following way.

TEC=(+3)×3+(−1.2)×{(+6)+(−3)}=5.4

Σfn=(+6: A/C capacity value)+(−3: P/W capacity value)=3

Since the TEC exceeds the Σfn, both control systems are selected. The vehicle interior environment integrated system 10 instructs the A/C to perform introduction of the capacity of 6 (setting the blow-off temperature to 21 degrees), and the P/W to perform recovering of the capacity of 3 (driving the P/W toward the open state and maintaining the open state of the P/W).

Then, the outside air temperature is 24 degrees, the indoor temperature is decreased from 27 degrees to 24 degrees to be saturated, and the set temperature remains at 23 degrees.

At this time, the required capacity values fns of the A/C and P/W are as follows. The A/C has the capacity value of 2 (consumption capacity value: a capacity value when setting the appropriate blow-off temperature to 22 degrees (which is increased by one degree from 21 degrees due to overshoot and reduction) in order to decrease the indoor temperature from 24 degrees to 23 degrees at the outside air temperature of 24 degrees). The P/W has the capacity value of 0 (zero) (which means that the indoor temperature of 24 degrees cannot be decreased even when receiving the introduction of the capacity from the outside resource while the P/W is in the open state).

The TEC and Σfn in this case are calculated in the following way.

TEC=(+3)×3+(−1.2)×{(+2)+(0)}6.6

Σfn=(+2: A/C capacity value)+(0: P/W capacity value)=2

Since the TEC exceeds the Σfn, both control systems are selected. However, the capacity value of the P/W is zero (0), and thus the actually driven system is only the A/C. The vehicle interior environment integrated system 10 instructs the A/C to perform introduction of the capacity of 2 (setting the blow-off temperature to 22 degrees), and the P/W to perform recovering of the capacity of 0 (that is, not to drive the P/W, while maintaining the open state of the P/W).

Furthermore, the outside air temperature is 24 degrees, the indoor temperature is decreased from 24 degrees to 23 degrees, and the set temperature remains at 23 degrees.

At this time, the required capacity values fns of the A/C and P/W are as follows. The A/C has the capacity value of 1 (consumption capacity value: a capacity value for continuing to set the blow-off temperature to 22 degrees in order to maintain the indoor temperature of 23 degrees at the outside air temperature of 24 degrees). The P/W has the capacity value of 1 (saving capacity value: a capacity value for interrupting the introduction of the capacity by one degree from the outside resource by shifting the P/W from the open state to the closed state).

The TEC and Σfn in this case are calculated in the following way.

TEC=(+3)×3+(−1.2)×{(+1)+(−1)}=9

Σfn=(+1: A/C capacity value)+(−1: P/W capacity value)=0

Since the TEC exceeds the Σfn, both control systems are selected. The vehicle interior environment integrated system 10 instructs the A/C to perform introduction of the capacity of 1 (setting and keeping the blow-off temperature at 22 degrees), and the P/W to perform recovering of the capacity of 1 (driving the P/W toward the closed state and maintaining the closed state of the P/W).

The outside air temperature, the indoor temperature, and the set temperature remain at 24 degrees, 23 degrees, and 23 degrees, respectively.

Since the TEC does not change, both control systems are selected. The A/C constantly functions actively, and the P/W remains in the closed state. It is noted that when the temperature falls below 23 degrees while the relation of TEC=9 is maintained, the P/W is driven passively (normally maintained in the closed state, but brought into and kept in the open state only for a predetermined time).

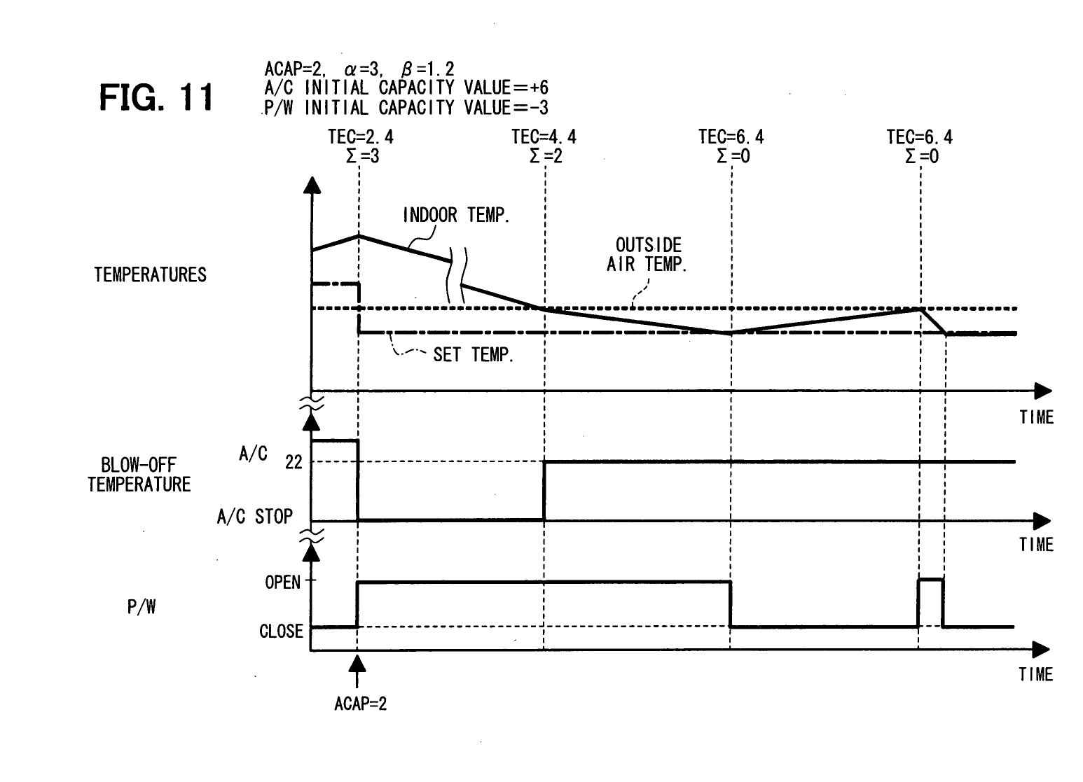

### (In the case of ACAP=2: see FIG. 11)

The initial state is a state in which the outside air temperature is 24 degrees, the indoor temperature is 27 degrees, and the set temperature decreases from 25 degrees to 23 degrees.

At this time, the required capacity values fns of the A/C and P/W are as follows, as shown in FIG. 7: the A/C has the capacity value of 6 (consumption capacity value), and the P/W has the capacity value of 3 (saving capacity value).

The TEC and Σfn in this case are calculated in the following way.

TEC=(+3)×2+(−1.2)×{(+6)+(−3)}=2.4

Σfn=(+6: A/C capacity value)+(−3: P/W capacity value)=3

Since the TEC falls below the Σfn, the control system having the required capacity value within a range below the Σfn is selected. In this example, only the P/W is selected. The vehicle interior environment integrated system 10 instructs the A/C to stop the function thereof, and the P/W to perform recovering of the capacity of 3 (driving the P/W toward the open state and maintaining the open state of the P/W). When another control system for controlling the temperature as the environmental factor exists and has a required capacity value below 2.4, this control system can also be employed.

Then, the outside air temperature is 24 degrees, the indoor temperature is decreased from 27 degrees to 24 degrees to be saturated, and the set temperature remains at 23 degrees.

At this time, the required capacity values fns of the A/C and P/W are as follows. The A/C has the capacity value of 2 (consumption capacity value: a capacity value when setting the appropriate blow-off temperature to 22 degrees in order to decrease the indoor temperature from 24 degrees to 23 degrees at the outside air temperature of 24 degrees). The P/W has the capacity value of 0 (zero) (which means that the indoor temperature of 24 degrees cannot be decreased even when receiving the introduction of the capacity from the outside resource while the P/W is in the open state).

The TEC and Σfn in this case are calculated in the following way.

TEC=(+3)×2+(−1.2)×{(+2)+(0)}=3.6

Σfn=(+2: A/C capacity value)+(0: P/W capacity value)=2

Since the TEC exceeds the Σfn, both control systems are selected. However, the capacity value of the P/W is zero (0), and thus the actually driven system is only the A/C. The vehicle interior environment integrated system 10 instructs the A/C to perform introduction of the capacity of 2 (setting the blow-off temperature to 22 degrees), and the P/W to perform recovering of the capacity of 0 (that is, not to drive the P/W, while maintaining the open state of the P/W).

Then, the outside air temperature is 24 degrees, the indoor temperature is decreased from 24 degrees to 23 degrees, and the set temperature remains at 23 degrees.

At this time, the required capacity values fns of the A/C and P/W are as follows. The A/C has the capacity value of 1 (consumption capacity value: a capacity value for continuing to set the blow-off temperature to 22 degrees in order to maintain the indoor temperature of 23 degrees at the outside air temperature of 24 degrees). The P/W has the capacity value of 1 (saving capacity value: a capacity value for interrupting the introduction of the capacity by one degree from the outside resource by shifting the P/W from the open state to the closed state).

The TEC and Σfn in this case are calculated in the following way.

TEC=(+3)×2+(−1.2)×{(+1)+(−1)}=6

Σfn=(+1: A/C capacity value)+(−1: P/W capacity value)=0

Since the TEC exceeds the Σfn, both control systems are selected. The vehicle interior environment integrated system 10 instructs the A/C to perform introduction of the capacity of 1 (setting and keeping the blow-off temperature at 22 degrees), and the P/v to perform recovering of the capacity of 1 (driving the P/W toward the closed state and maintaining the closed state of the P/W)

The outside air temperature, the indoor temperature, and the set temperature remain at 24 degrees, 23 degrees, and 23 degrees, respectively.

Since the TEC does not change, both control systems are selected. The A/C constantly functions actively, and the P/W remains in the closed state. It is noted that when the temperature falls below 23 degrees while the relation of TEC=6 is maintained, the P/W is driven passively (normally maintained in the closed state, but brought into and kept in the open state only for a predetermined time).

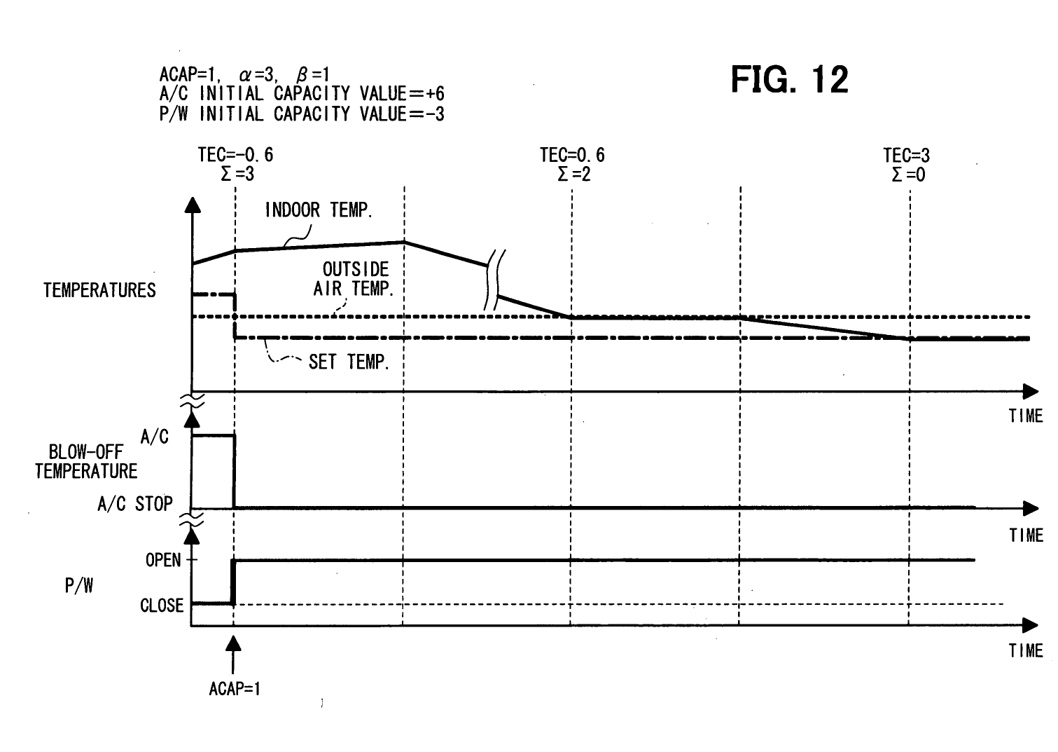

### (In the case of ACAP=1: see FIG. 12)

The initial state is a state in which the outside air temperature is 24 degrees, the indoor temperature is 27 degrees, and the set temperature decreases from 25 degrees to 23 degrees.

At this time, the required capacity values fns of the A/C and P/W are as follows, as shown in FIG. 7: the A/C has the capacity value of 6 (consumption capacity value), and the P/W has the capacity value of 3 (saving capacity value).

The TEC and Σfn in this case are calculated in the following way.

TEC=(+3)×1+(−1.2)×{(+6)+(−3)}=−0.6

Σfn=(+6: A/C capacity value)+(−3: P/W capacity value)=3

Since the TEC falls below the Σfn, only the P/W is selected. The vehicle interior environment integrated system 10 instructs the A/C to stop the function thereof, and the P/W to perform recovering of the capacity of 3 (driving the P/W toward the open state and maintaining the open state of the P/W). When another control system for controlling the temperature as the environmental factor exists, and has a required capacity value below −0.6, this control system can also be employed.

Then, the opening operation of the P/W is performed, whereby the outside air temperature becomes 24 degrees, the indoor temperature is decreased from 27 degrees to 24 degrees to be saturated, and the set temperature remains at 23 degrees.

At this time, the required capacity values fns of the A/C and P/W are as follows. The A/C has the capacity value of 2 (consumption capacity value: a capacity value when setting the appropriate blow-off temperature to 22 degrees in order to decrease the indoor temperature from 24 degrees to 23 degrees at the outside air temperature of 24 degrees). The P/W has the capacity value of 0 (zero) (which means that the indoor temperature of 24 degrees cannot be decreased even when receiving the introduction of the capacity from the outside resource while the P/W is in the open state).

The TEC and Σfn in this case are calculated in the following way.

TEC=(+3)×1+(−1.2)×{(+2)+(0)}=0.6

Σfn=(+2: A/C capacity value)+(0: P/W capacity value)=2

Since the TEC falls below the Σfn, only the P/W is selected. The vehicle interior environment integrated system 10 instructs the A/C to stop the function thereof, and the P/W to perform recovering of the capacity of 0 (that is, not to drive the P/W, while maintaining the open state of the P/W). In this case, the P/W remains in the opened state. This present state is maintained unless the indoor temperature, the outside air temperature, or the set temperature changes (for example, the outside air temperature changes) due to any influence.

At this time, the outside air temperature decreases from 24 degrees to 23 degrees, the indoor temperature decreases from 24 degrees to 23 degrees, and the set temperature remains at 23 degrees.

At this time, the required capacity values fns of the A/C and P/W are as follows. The A/C has the capacity value of 0 (zero) (consumption capacity value: this capacity does not need to be exhibited because the indoor temperature of 23 degrees may be maintained at the outside air temperature of 23 degrees). The P/W has the capacity value of 0 (zero) (consumption capacity value: In this case, because the outside air temperature is identical to the indoor temperature, the outside air temperature is disturbed, and thus does not act on the vehicle interior. That is, the disturbance does not need to be interrupted).

The TEC and Σfn in this case are calculated in the following way.

TEC=(+3)×1+(−1.2)×{(0)+(0)}=3

Σfn=(0: A/C capacity value)+(0: P/W capacity value)=0

Since the TEC exceeds the Σfn, both control systems are selected. Since the capacity values of both control systems are 0 (zero), the vehicle interior environment integrated system 10 instructs both A/C and P/W to stop their functions. This present state is maintained unless the indoor temperature and the set temperature are close to each other due to any influence (for example, due to a change in outside air temperature), specifically, unless the set temperature is increased, or unless the user executes any operation.

In this embodiment, this state does not change if the TEC and the Σfn do not change and remain as they are. The user's manual selection is received from an operational portion of the active operation section whose operation is not selected, thereby allowing the active operation section to be operated. In this embodiment, only when the TEC is equal to or less than zero, the user's manual operation selection is received by the operation of the temperature setting section 146 or the air amount setting section 145 in the air conditioning control system 100. Since the environmental luxury degree setting section 2 can be operated at any time, the operation of the luxury degree setting section 2 can change the present environmental luxury degree thereby changing the present state.

In the description as mentioned above, the selection methods of the low-level control systems 100 to 800 in the vehicle interior environment integrated system 10 have been described using the “temperature” of the environmental factor as one example. Likewise, any one of “humidity”, “light”, “sound”, and “space” which are other environmental factors can be applied. For example, a target value setting section (for example, in the case of “temperature”, the temperature setting switch 146 for defining the set temperature) is provided in relation to the environment factor, for allowing the user to input a target value corresponding to the environmental factor. Also, a present value detection section (in the case of “temperature”, the inside air temperature sensor 121) is provided in relation to the environmental factor, for detecting a present value of the environmental factor. Further, a disturbance value detection section is provided in relation to the environmental factor, for detecting a present value of an element which may lead to the disturbance of the environmental factor (in the case of “temperature”, the outside air temperature sensor 122). The vehicle interior environment integrated system 10 obtains the required capacity values fns based on the above-described target value, present value, and disturbance value from the respective low-level control systems to complete the table as shown in FIG. 6. With reference to this table, the integrated system 10 calculates the total luxury-degree-reflecting capacity value TEC and the integrated required capacity value Σfn, and then selects the low-level control system based on the TEC and Σfn calculated. Thus, the integrated system 10 can be configured to control the environmental factor of interest using the driving section of the selected control system.

For example, the low-level control system for controlling the environmental factor of “light” includes the interior light control system 300, the sunshade control system 400, and the dimming glass control system 500. A target value setting section may be provided for setting a target value of light or brightness. A sensor may be further provided for detecting a present value of brightness of the vehicle interior (for example, a solar radiation sensor provided in the position of the vehicle interior which is not affected by the external light). The solar radiation sensors 521 to 526 may be used as the sensor for detecting the brightness of the vehicle exterior (disturbance value). The table shown in FIG. 6 may be made based on the above-described target value, present value, and disturbance value. The TEC and Σfn at that time may be calculated based on the table, and thus the system selection control may be executed based on the calculated TEC and Σfn as mentioned above. The environmental factor may be controlled using the driving section of the selected control system.

The target setting section for setting the target value of brightness may not be provided independently. The existing operation section may be defined as the target setting section to set the target value of the brightness. For example, the target value of the brightness can be totally calculated based on the following operational state of the setting section.
The number of lighting operations of the lighting sections 351 to 353 . . . of the interior light control system 300 (The larger the number, the higher the target value of brightness is set.)
A set mode by the mode setting section 341 of the interior light control system 300 (The target value of brightness is set higher in the second mode, the first mode, and the third mode, in that order.)
A set mode by the mode setting section 441 of the sunshade control system 400 (The target value of the automatic mode is set higher than that of the manual mode.)
A set mode by the mode setting section 541 of the dimming glass control system 500 (The target value of the automatic mode is set higher than that of the manual mode.)

As to the “light”, the interior light control system 300 can control colors. For example, an operation section serving as the target value setting section is provided for setting a target value indicative of a sense of unity with the vehicle exterior or a sense of opening to the vehicle exterior. As the set value is larger, the brightness or color of the vehicle interior can be similar to that of the vehicle exterior.

For example, the control systems for controlling the environmental factor of “sound” include the power window control system 200, the audio control system 600, and the noise canceller control system 700. The term “sound” as used herein means ease of listening to a target sound. A target setting section is provided for setting a target value indicative of the ease of listening to the target sound. A sensor (for example, a noise detection microphone 2011) is provided for detecting a present value of the ease of listening to the target sound in the vehicle interior. The table shown in FIG. 6 may be made based on the above-described target value and present value. The TEC and Σfn at that time may be calculated based on the table, and thus the system selection control may be executed based on the calculated TEC and Σfn as mentioned above. The environmental factor may be controlled using the driving section of the selected control system.

The target setting section for setting the target value of sound (ease of listening to the target sound) may not be provided independently. The existing operation section may be defined as the target setting section to set the target value of sound based on the operational state. For example, the target value of the sound can be totally calculated based on the following operational state of the operation section.
An operational state of a volume adjustment section 641 of the audio control system 600 (The larger the amount of sound, the larger the S/N is set.)

The environmental factor of “sound” is not limited only to one for defining the ease of listening to the target sound as the target value, but may be one for defining the degree of silence as the target value. In this case, the target setting section is adapted to set the noise level in the vehicle interior, and the noise canceller 730 serving as the driving section serves as a system for canceling all noise in the vehicle interior to control the degree of silence.

The systems for controlling the environmental factor of “space” (which means not an actual space, but a “sense of space” felt by the user) include the power window control system 200, the interior light control system 300, the sunshade control system 400, the dimming control system 500, the audio control system 600, the noise canceller control system 700, and the memory sheet control system 800. The term “space” as used herein means the sense of space felt by a passenger on the driver seat. A target setting section is provided for setting a target value of the sense of space. Sensors (for example, position sensors 821 to 827, a solar sensor for detecting the brightness of the vehicle interior, and the noise detection microphone 2011) are provided for detecting the present value of the sense of space in the vehicle interior. The table shown in FIG. 6 may be made based on the above-described target value and present value. The TEC and Σfn at that time may be calculated based on the table, and thus the system selection control may be executed based on the calculated TEC and Σfn as mentioned above. The environmental factor may be controlled using the driving section of the selected control system.

The target setting section for setting the target value of the sense of space may not be provided independently. The existing operation section may be defined as the target setting section to set the target value of the space sense based on the operational state.

Also, as to the environmental factor of “humidity”, the system selection can be executed using the above-described method.

The sunshade control system 400 for shielding the incident light into the vehicle interior, and the dimming control system 500 can be added as the low-level control system for assisting in control of the environmental factor of “temperature”.

The embodiments of the invention have been described above, but are for illustrative purpose only. The invention is not limited thereto, and various modifications can be made to the presently disclosed embodiments without departing from the scope of the accompanying claims.

For example, a main object of the control of optimization among the vehicle interior environmental factors is defined as a main vehicle interior environmental factor. In contrast, another vehicle interior environmental factor concomitantly changing is defined as a dependent vehicle interior environmental factor. A subsidiary driving section of the low-level control system can be provided for control of optimization of the dependent vehicle interior environmental factor. In this case, the vehicle interior environment integrated system can control the subsidiary driving section. That is, even when the state of the dependent vehicle interior environmental factor is disturbed due to a cause in the system by the control operation of the main vehicle interior environmental factor, the subsidiary driving section is provided and controlled together with the main driving section by the vehicle interior environment integrated system, thereby enabling elimination of the disturbance. This can totally create the more comfort vehicle interior environment. In this case, a part of the main driving section of the low-level control system for performing the control of optimization of the main vehicle interior environmental factor can also serve as the subsidiary driving section. This enables reduction in weight of the system structure which prevents the disturbance of the dependent vehicle interior environmental factor.

Specifically, when the main vehicle interior environmental factor is the vehicle interior temperature, the main driving sections can be the vehicle interior air conditioner (the above-described A/C) and the power window mechanism (the above-described P/W). In the vehicle interior air conditioner, a blower or the like is a noise generating source. When the window is opened by the power window mechanism, noise enters the interior of the vehicle from the outside. Thus, the dependent vehicle interior environment factors can be levels of noise in the vehicle interior and of a signal sound (music sound or important sound outside the vehicle (a horn sound of another car, a siren sound of an emergent vehicle, or an alarm sound of a crossing plate, or the like)), and more specifically, the S/N ratio. In this case, the subsidiary driving sections can include an audio system for outputting audio as the signal sound, and a noise canceller for reducing the noise level. That is, the audio system enhances the music sound level, while the noise canceller reduces the noise level, both of which contribute to improvement of the S/N ratio.

In this case, the power window mechanism which is one of the main driving sections can also serve as the subsidiary driving section. That is, when the window is opened by the power window mechanism for the control of the vehicle interior temperature, noise outside the vehicle enters the vehicle interior. However, by shifting an object of the main control toward the air conditioner which is the active operation section, the power window mechanism can be converted to the subsidiary environment adjustment section for shielding the noise outside the vehicle. That is, the power window mechanism is operated in the shielding direction, so it can appropriately control the temperature of the vehicle interior, while improving the S/N ratio.

In this case, a vehicle interior S/N ratio setting section (S/N ratio input means) can be provided which is operated for input by the user in the vehicle interior. Thus, the vehicle interior environment integrated system can be configured to control cooperation among the audio system, the noise canceller, and the power window mechanism so as to obtain the vehicle interior S/N ratio indicated by the operational state (or the input state) of the vehicle interior S/N ratio setting section. The conventional audio system can change only the amount of sound. Thus, as the noise level becomes higher, there is no way to increase a relative level of the music sound in the conventional system other than to set the amount of sound output to such a level to overcome the noise level. This may place a higher load on auditory sense. In this embodiment, the use of the above-described vehicle interior S/N ratio setting section can increase the relative level of the music sound, taking into consideration reduction in noise level. This can reduce the load on the auditory sense, and freely adjust the relative level of the music sound.

Suppose, for example, the vehicle interior air conditioner and the power window mechanism each are provided as the driving section having a control capacity of the environmental factor of “temperature (temperature of the vehicle interior)”. Furthermore, the audio system, the noise canceller, and the power window mechanism are provided as the driving section having a control capacity of the environmental factor of “sound (levels of noise and signal sounds)”. In this case, the power window mechanism is concerned with both environmental factors. The luxury redundant capacity values TECs regarding the environmental factors of “temperature” and “sound” in this case can be calculated by multiplying the required capacity of each driving section by an intrinsic coefficient β (negative coefficient) by the following formula 2.

TEC=α×ACAP+β×Σ(γn×f′n) (Formula 2)

That is, the total required capacity value Σfn of each environmental factor is calculated by multiplying a required capacity value fn of each low-level control system by a corresponding coefficient γn and by adding up and integrating the thus-obtained values in the following way.

### (Environmental Factor: Temperature)

Σfn=γ1×f′1+γ2×f′2

### (Environmental Factor: Sound)

Σfn=γ3×f′3+γ4×f′4+γ5×f′5

In the above formula, f′1 is a required capacity value of the vehicle interior air conditioner for the environmental factor of “temperature”, and f′2 is a required capacity value of the power window mechanism for the environmental factor of “temperature”. Likewise, in the above formula, f′3 is a required capacity value of the power window mechanism for the environmental factor of “sound”, f′4 is a required capacity value of the audio system for the environmental factor of “sound”, and f′5 is a required capacity value of the noise canceller for the environmental factor of “sound”. The coefficient γn associated with the power window mechanism is variable according to the target temperature value and the set value of the S/N ratio. The coefficient γ associated with another vehicle interior air conditioner, the audio system, or the noise canceller is set to one (1).

The coefficient γn is to define which environmental factor is preferentially controlled for each of the low-level control systems which may affect the environmental factors. The lower the S/N ratio set by the S/N ratio setting section 641, or the more apart the target temperature value is from the present value, the higher the coefficient γ associated with the environmental factor of “temperature” of the power window mechanism is set, and the lower the coefficient γ associated with the environmental factor of “sound” of the power window mechanism is set. Conversely, the higher the S/N ratio set by the S/N ratio setting section, or the closer to the present value the target temperature value is set by the temperature setting section 146, the lower the coefficient γ associated with the environmental factor of “temperature” of the power window mechanism is set, and the higher the coefficient γ associated with the environmental factor of “sound” of the power window mechanism is set. Thus, for the high S/N ratio set, the power window mechanism preferentially controls the environmental factor of “sound”, and is not driven for the purpose of controlling the environmental factor of “temperature”. Conversely, when the present temperature is largely apart from the target temperature, the power window mechanism preferentially controls the environmental factor of “temperature”, and is not driven for the purpose of controlling the environmental factor of “sound”.

The system in the above-described embodiments can achieve both of “power saving” and “comfort of the temperature”, but the invention is not limited thereto. For example, the reference for calculation of the luxury redundant capacity value TEC may be changed so as to achieve both of “defensive safety (security)” and “comfort of the brightness”. Furthermore, “health”, “comfort of the indoor sound”, or the like may be employed as the environmental factor.

For example, the above-described embodiment and examples of the present invention may include the following features.

A vehicle interior environment control system according to an aspect of the present invention includes: a plurality of environment adjustment sections (130, 230, 330, 430, 530, 630, 730, 830) adapted to operate in cooperation with each other so as to control optimization of an environment of an interior of a vehicle; grading parameter setting means (100, 200, 300, 400, 500, 600, 700, 800) for setting a grading parameter indicative of a capacity grade of each of the environment adjustment sections in one-to-one relation to the environment adjustment sections; environmental luxury degree setting means (2) for adjustably setting an environmental luxury degree desired by a user for a total environmental adjustment state of the vehicle interior, achieved by the cooperation between the environment adjustment sections; and integrated control means (10) that controls the cooperation between the environment adjustment sections, such that as the environmental luxury degree set by the environmental luxury degree setting means becomes higher, the environment adjustment section with the higher capacity grade indicated by the grading parameter is preferentially operated.

The vehicle interior environment control system may further include environmental luxury degree input means which is operated for input by a user in the vehicle interior, wherein the environmental luxury degree setting means sets the environmental luxury degree based on an input state of the environmental luxury degree input means. Alternatively, the vehicle interior environment control system may further include required capacity value setting means (100, 200, 300, 400, 500, 600, 700) for setting a required capacity value for optimization of the vehicle interior environment as a numerical value parameter for each of the environment adjustment sections, the numerical value parameter being directly comparable between the environment adjustment sections. In this case, the integrated control means may include: total luxury-degree-reflecting capacity value calculation means for calculating a total luxury-degree-reflecting capacity value which is a numerical value parameter directly comparable with the required capacity value, based on the set value of the environmental luxury degree; integrated required-capacity-value computation means for computing an integrated required capacity value by integrating and computing the required capacity values set in the respective environment adjustment sections according to a pre-set computation procedure; and capacity value comparison means for comparing the total luxury-degree-reflecting capacity value with the integrated required capacity value. Furthermore, the integrated control means may control the cooperation between the environment adjustment sections such that as the integrated required capacity value is closer to the total luxury-degree-reflecting capacity value, the environment adjustment section having the lower capacity grade is preferentially performed. In this case, the integrated required-capacity-value computation means may add up and integrate the required capacity values from the required capacity value setting means.

Alternatively, the environment adjustment sections may have the respective independent low-level control systems 100, 200, 300, 400, 500, 600, 700, 800. In this case, the low-level control system 100, 200, 300, 400, 500, 600, 700, 800 may includes: a low-level control main body for comparing a present detected value of a vehicle interior environmental control factor to be controlled with a target value, and for performing feedback control of a control amount of interest based on a comparison result such that the present detected value is close to the target value; the required capacity value setting means for updating and setting the required capacity value based on a set value of the control amount according to a change of the set value by the feedback control; and required capacity value output means for outputting and feeding back the required capacity value to an upper-level control system serving as the integrated control means. In this case, the integrated required-capacity-value computation means in the upper-level control system is adapted to compute the integrated required capacity value based on an feedback input of the required capacity value from each of the low-level control systems.

The required capacity value setting means may sets a maximum capacity value of the environment adjustment section as an initial value of the required capacity value. Alternatively, the required capacity value may also serve as the grading parameter, and the environment adjustment section having the larger required capacity value set may be defined as positioned on an upper level of the capacity grade. In addition, the upper-level control system may include: luxury redundant capacity value computation means serving as the capacity value comparison means for computing a luxury redundant capacity value represented by a difference between the total luxury-degree-reflecting capacity value and the integrated required capacity value; and environment adjustment section selecting means for selecting which one of the environment adjustment sections is operated based on a comparison result between the luxury redundant capacity value and the integrated required capacity value from each of the low-level control systems.

For example, the temperature of the vehicle interior may be defined as the vehicle interior environmental factor. In this case, all of the target value, the required capacity value, the integrated required capacity value, and the luxury redundant capacity value have a dimension of temperature.

When the luxury redundant capacity value exceeds the integrated required capacity value, the environment adjustment section selecting means selects all environment adjustment sections as the operable environment adjustment section. In this case, when the luxury redundant capacity value falls below the integrated required capacity value, the environment adjustment section selecting means preferentially selects one with the smaller required capacity value from among the environment adjustment sections. Alternatively, when the luxury redundant capacity value falls below the integrated required capacity value, the environment adjustment section selecting means selects a part of the environment adjustment sections in order to maximize the integrated required capacity value in a range below the luxury redundant capacity value. Alternatively, when the luxury redundant capacity value falls below the integrated required capacity value, the environment adjustment section selecting means selects the part of the environment adjustment sections such that the integrated required capacity value is maximized in a form to exclude one or more environment adjustment sections positioned on an upper level of a rank order of the required capacity values.

The environment adjustment section may include either an active operation section or a passive operation section, the active operation section being adapted to operate so as to offset disturbance from a vehicle exterior, which may keep the vehicle interior environmental factor of interest away from the target value, by positively introducing energy, the passive operation section being adapted to operate so as to prevent the disturbance from entering the vehicle interior in the same manner, or so as to use disturbance acting in such a direction to put the vehicle interior environmental factor of interest closer to the target value. In this case, the required capacity value setting means may be adapted to set the required capacity values with opposite signs to each other for the active and passive operation sections such that the active operation section contributes to increase the integrated required capacity value, while the passive operation section contributes to decrease the integrated required capacity value.

The control system may further include disturbance comparison means for detecting a present vehicle interior value of the vehicle interior environmental factor and for comparing the present vehicle interior value with a vehicle exterior disturbance value corresponding thereto and the target value, and passive operation section control means for controlling an operation of the passive operation section based on a comparison result. In this case, the passive operation section control means may operate so as to use the disturbance when a difference determined by subtracting the target value from the present vehicle interior value has the same sign as that of a difference determined by subtracting the vehicle exterior disturbance value from the present vehicle interior value, and likewise operates so as to interrupt the disturbance when said differences have opposite signs.

Even in this case, the vehicle interior temperature may be defined as the vehicle interior environmental factor. Here, the active operation section may be a vehicle interior air conditioner, and the passive operation section may be a power window mechanism. The power window mechanism is adapted to operate in an opening direction when the vehicle interior temperature is lower than the target temperature and the vehicle exterior temperature is higher than the vehicle interior temperature, or when the vehicle interior temperature is higher than the target temperature and the vehicle exterior temperature is lower than the vehicle interior temperature. The power window mechanism is further adapted to operate in a shielding direction when the vehicle interior temperature is lower than the target temperature and the vehicle exterior temperature is lower than the vehicle interior temperature, or when the vehicle interior temperature is higher than the target temperature and the vehicle exterior temperature is higher than the vehicle interior temperature.

Alternatively, the required capacity value setting means may be adapted to set the required capacity values with opposite signs to each other for the active and passive operation sections such that the active operation section contributes to decrease the luxury redundant capacity value, while the passive operation section contributes to increase the luxury redundant capacity value. In this case, when the luxury redundant capacity value falls below the required capacity value of the active operation section, the environment adjustment section selecting means preferentially selects the passive operation section rather than the active operation section. Alternatively, when the luxury redundant capacity value falls below the integrated required capacity value while the environment adjustment sections in operational selection include both of the active operation section and the passive operation section, the environment adjustment section selecting means excludes at least a part of the active operation section in the operational selection from the selection. Furthermore, when the luxury redundant capacity value is zero or a negative value while the environment adjustment sections in operational selection include both of the active operation section and the passive operation section, the environment adjustment section selecting means excludes the entire active operation section in the operational selection from the selection, and selects only the passive operating section to be operated. In this case, when the luxury redundant capacity value is recovered to a predetermined level on a positive value side while only the passive operation section is selected to be operated, the environment adjustment operation section selecting means recover and select at least a part of the active operation section which has been selected and excluded in such a range that the luxury redundant capacity value does not fall below the integrated required capacity value.

The vehicle interior environment control system may further include manual selection receiving means for receiving user's manual selection of the active operation section whose operation is not selected by the environment adjustment section selecting means. In this case, the manual selection receiving means receives the manual selection only when the luxury redundant capacity value is equal to or less than zero.

In the vehicle interior environment control system, a main object of the control of optimization between the vehicle interior environmental factors may be defined as a main vehicle interior environmental factor, and another vehicle interior environmental factor concomitantly changing may be defined as a dependent vehicle interior environmental factor. In this case, a subsidiary environment adjustment section may be provided for controlling optimization of the dependent vehicle interior environmental factor, and the integrated control system may also control the subsidiary environment adjustment section. Here, a part of the main environment adjustment section for performing the control of optimization of the main vehicle interior environmental factor may also serve as the subsidiary environment adjustment section.

Furthermore, the main vehicle interior environmental factor may be the vehicle interior temperature, and the main environment adjustment sections may be a vehicle interior air conditioner and a power window mechanism. In this case, the dependent vehicle interior environment factors are levels of noise and a signal sound in the vehicle interior, and the subsidiary environment adjustment section may include an audio system for outputting audio as the signal sound, and a noise canceller for reducing the noise level. In addition, the power window mechanism serving as one of the main environment adjustment sections also serves as the subsidiary environment adjustment section.

The vehicle interior environment control system may further include vehicle interior S/N ratio input means which is operated for input by the user in the vehicle interior. In this case, the integrated control means may control cooperation among the audio system, the noise canceller, and the power window mechanism so as to obtain a vehicle interior S/N ratio indicated by an input state of the vehicle interior S/N ratio input means.

Such changes and modifications are to be understood as being within the scope of the present invention as defined by the appended claims.

What is claimed is:

1. A vehicle interior environment control system, comprising:
a plurality of environment adjustment sections adapted to operate in cooperation with each other so as to control optimization of an environment of an interior of a vehicle;
grading parameter setting means for setting a grading parameter indicative of a capacity grade of each of the environment adjustment sections in one-to-one relation to the environment adjustment sections;
environmental luxury degree setting means for adjustably setting an environmental luxury degree desired by a user for a total environmental adjustment state of the vehicle interior, achieved by the cooperation between the environment adjustment sections; and
integrated control means for controlling the cooperation between the environment adjustment sections, such that as the environmental luxury degree set by the environmental luxury degree setting means becomes higher, the environment adjustment section with the higher capacity grade indicated by the grading parameter is preferentially operated.

2. The vehicle interior environment control system according to claim 1, further comprising
environmental luxury degree input means which is operated for input by a user in the vehicle interior, wherein the environmental luxury degree setting means sets the environmental luxury degree based on an input state of the environmental luxury degree input means.

3. The vehicle interior environment control system according to claim 1, further comprising
required capacity value setting means for setting a required capacity value for optimization of the vehicle interior environment as a numerical value parameter for each of the environment adjustment sections, the numerical value parameter being directly comparable between the environment adjustment sections,
wherein the integrated control means includes:
total luxury-degree-reflecting capacity value calculation means for calculating a total luxury-degree-reflecting capacity value which is a numerical value parameter directly comparable with the required capacity value, based on the set value of the environmental luxury degree;
integrated required-capacity-value computation means for computing an integrated required capacity value by integrating and computing the required capacity values set in the respective environment adjustment sections according to a pre-set computation procedure; and
capacity value comparison means for comparing the total luxury-degree-reflecting capacity value with the integrated required capacity value, and
wherein the integrated control means controls the cooperation between the environment adjustment sections such that as the integrated required capacity value is closer to the total luxury-degree-reflecting capacity value, the environment adjustment section having the lower capacity grade is preferentially performed.

4. The vehicle interior environment control system according to claim 3, wherein the integrated required-capacity-value computation means adds up and integrates the required capacity values from the required capacity value setting means.

5. The vehicle interior environment control system according to claim 3, wherein the environment adjustment sections have the respective independent low-level control systems, and
wherein the low-level control system includes:
a low-level control main body for comparing a present detected value of a vehicle interior environmental control factor to be controlled with a target value, and for performing feedback control of a control amount of interest based on a comparison result such that the present detected value is close to the target value;
the required capacity value setting means for updating and setting the required capacity value based on a set value of the control amount according to a change of the set value by the feedback control; and
required capacity value output means for outputting and feeding back the required capacity value to an upper-level control system serving as the integrated control means, and
wherein the integrated required-capacity-value computation means in the upper-level control system is adapted to compute the integrated required capacity value based on an feedback input of the required capacity value from each of the low-level control systems.

6. The vehicle interior environment control system according to claim 5, wherein the required capacity value setting means sets a maximum capacity value of the environment adjustment section as an initial value of the required capacity value.

7. The vehicle interior environment control system according to claim 5, wherein the required capacity value also serves as the grading parameter, and the environment adjustment section having the larger required capacity value set is defined as positioned on an upper level of the capacity grade.

8. The vehicle interior environment control system according to claim 7, wherein the upper-level control system includes:
luxury redundant capacity value computation means serving as the capacity value comparison means for computing a luxury redundant capacity value represented by a difference between the total luxury-degree-reflecting capacity value and the integrated required capacity value; and
environment adjustment section selecting means for selecting which one of the environment adjustment sections is operated based on a comparison result between the luxury redundant capacity value and the integrated required capacity value from each of the low-level control systems.

9. The vehicle interior environment control system according to claim 8, wherein the temperature of the vehicle interior is defined as the vehicle interior environmental factor, and
wherein all of the target value, the required capacity value, the integrated required capacity value, and the luxury redundant capacity value have a dimension of temperature.

10. The vehicle interior environment control system according to claim 8, wherein, when the luxury redundant capacity value exceeds the integrated required capacity value, the environment adjustment section selecting means selects all environment adjustment sections as the operable environment adjustment section.

11. The vehicle interior environment control system according to claim 10, wherein, when the luxury redundant capacity value falls below the integrated required capacity value, the environment adjustment section selecting means preferentially selects one with the smaller required capacity value from among the environment adjustment sections.

12. The vehicle interior environment control system according to claim 8, wherein, when the luxury redundant capacity value falls below the integrated required capacity value, the environment adjustment section selecting means selects a part of the environment adjustment sections in order to maximize the integrated required capacity value in a range below the luxury redundant capacity value.

13. The vehicle interior environment control system according to claim 12, wherein, when the luxury redundant capacity value falls below the integrated required capacity value, the environment adjustment section selecting means selects the part of the environment adjustment sections such that the integrated required capacity value is maximized in a form to exclude one or more environment adjustment sections positioned on an upper level of a rank order of the required capacity values.

14. The vehicle interior environment control system according to claim 5, wherein the environment adjustment section includes either an active operation section or a passive operation section, the active operation section being adapted to operate so as to offset disturbance from a vehicle exterior, which may keep the vehicle interior environmental factor of interest away from the target value, by positively introducing energy, the passive operation section being adapted to operate so as to prevent the disturbance from entering the vehicle interior in the same manner, or so as to use disturbance acting in such a direction to put the vehicle interior environmental factor of interest closer to the target value, and
wherein the required capacity value setting means is adapted to set the required capacity values with opposite signs to each other for the active and passive operation sections such that the active operation section contributes to increase the integrated required capacity value, while the passive operation section contributes to decrease the integrated required capacity value.

15. The vehicle interior environment control system according to claim 14, further comprising:
disturbance comparison means for detecting a present vehicle interior value of the vehicle interior environmental factor, and for comparing the present vehicle interior value with a vehicle exterior disturbance value corresponding thereto and the target value; and
passive operation section control means for controlling an operation of the passive operation section based on a comparison result.

16. The vehicle interior environment control system according to claim 15, wherein the passive operation section control means operates so as to use the disturbance when a difference determined by subtracting the target value from the present vehicle interior value has the same sign as that of a difference determined by subtracting the vehicle exterior disturbance value from the present vehicle interior value, and likewise operates so as to interrupt the disturbance when said differences have opposite signs.

17. The vehicle interior environment control system according to claim 16, wherein the vehicle interior temperature is defined as the vehicle interior environmental factor,
wherein the active operation section is a vehicle interior air conditioner, and
wherein the passive operation section is a power window mechanism, the power window mechanism being adapted to operate in an opening direction when the vehicle interior temperature is lower than the target temperature and the vehicle exterior temperature is higher than the vehicle interior temperature, or when the vehicle interior temperature is higher than the target temperature and the vehicle exterior temperature is lower than the vehicle interior temperature, the power window mechanism being further adapted to operate in a shielding direction when the vehicle interior temperature is lower than the target temperature and the vehicle exterior temperature is lower than the vehicle interior temperature, or when the vehicle interior temperature is higher than the target temperature and the vehicle exterior temperature is higher than the vehicle interior temperature.

18. The vehicle interior environment control system according to claim 13, wherein the required capacity value setting means is adapted to set the required capacity values with opposite signs to each other for the active and passive operation sections such that the active operation section contributes to decrease the luxury redundant capacity value, while the passive operation section contributes to increase the luxury redundant capacity value.

19. The vehicle interior environment control system according to claim 18, wherein, when the luxury redundant capacity value falls below the required capacity value of the active operation section, the environment adjustment section selecting means preferentially selects the passive operation section rather than the active operation section.

20. The vehicle interior environment control system according to claim 19, wherein, when the luxury redundant capacity value falls below the integrated required capacity value while the environment adjustment sections in operational selection include both of the active operation section and the passive operation section, the environment adjustment section selecting means excludes at least a part of the active operation section in the operational selection from the selection.

21. The vehicle interior environment control system according to claim 20, wherein, when the luxury redundant capacity value is zero or a negative value while the environment adjustment sections in operational selection include both of the active operation section and the passive operation section, the environment adjustment section selecting means excludes the entire active operation section in the operational selection from the selection, and selects only the passive operating section to be operated.

22. The vehicle interior environment control system according to claim 21, wherein, when the luxury redundant capacity value is recovered to a predetermined level on a positive value side while only the passive operation section is selected to be operated, the environment adjustment operation section selecting means recovers and selects at least a part of the active operation section which has been selected and excluded in such a range that the luxury redundant capacity value does not fall below the integrated required capacity value.

23. The vehicle interior environment control system according to claim 18, further comprising manual selection receiving means for receiving user's manual selection of the active operation section whose operation is not selected by the environment adjustment section selecting means.

24. The vehicle interior environment control system according to claim 23, wherein the manual selection receiving means receives the manual selection only when the luxury redundant capacity value is equal to or less than zero.

25. The vehicle interior environment control system according to claim 1, wherein a main object of the control of optimization between the vehicle interior environmental factors is defined as a main vehicle interior environmental factor, and another vehicle interior environmental factor concomitantly changing is defined as a dependent vehicle interior environmental factor,
wherein a subsidiary environment adjustment section is provided for controlling optimization of the dependent vehicle interior environmental factor, and
wherein the integrated control system also controls the subsidiary environment adjustment section.

26. The vehicle interior environment control system according to claim 25, wherein a part of the main environment adjustment section for performing the control of optimization of the main vehicle interior environmental factor also serves as the subsidiary environment adjustment section.

27. The vehicle interior environment control system according to claim 26, wherein the main vehicle interior environmental factor is the vehicle interior temperature, and the main environment adjustment sections are a vehicle interior air conditioner and a power window mechanism,
wherein the dependent vehicle interior environment factors are levels of noise and a signal sound in the vehicle interior, and the subsidiary environment adjustment section includes an audio system for outputting audio as the signal sound, and a noise canceller for reducing the noise level, and
wherein the power window mechanism serving as one of the main environment adjustment sections also serves as the subsidiary environment adjustment section.

28. The vehicle interior environment control system according to claim 27, further comprising vehicle interior S/N ratio input means which is operated for input by the user in the vehicle interior,
wherein the integrated control means controls cooperation among the audio system, the noise canceller, and the power window mechanism so as to obtain a vehicle interior S/N ratio indicated by an input state of the vehicle interior S/N ratio input means.
